(19) United States
(12) Patent Application Publication
(10) Pub. No.: US 2022/0366238 A1
(43) Pub. Date: Nov. 17, 2022

(54) METHOD AND APPARATUS FOR ADJUSTING QUANTIZATION PARAMETER OF RECURRENT NEURAL NETWORK, AND RELATED PRODUCT

(71) Applicant: Anhui Cambricon Information Technology Co., Ltd., Anhui (CN)

(72) Inventors: Shaoli LIU, Anhui (CN); Shiyi ZHOU, Anhui (CN); Xishan ZHANG, Anhui (CN); Hongbo ZENG, Anhui (CN)

(21) Appl. No.: 17/622,647

(22) PCT Filed: Aug. 20, 2020
(86) PCT No.: PCT/CN2020/110142

§ 371 Date: Dec. 23, 2021

(30) Foreign Application Priority Data
Aug. 27, 2019 (CN) 201910798228.2
Sep. 19, 2019 (CN) 201910888141.4

(51) Int. Cl. G06N 3/08; G06K 9/62

(52) U.S. Cl. CPC G06N 3/08; G06K 9/6265

(57) ABSTRACT

A method for adjusting quantization parameters of a recurrent neural network according to an embodiment of the present disclosure may determine a target iteration interval according to the data variation range of the data to be quantized to adjust quantization parameters in the recurrent neural network computation according to the target iteration interval. The quantization parameter adjustment method, apparatus, and related products of the recurrent neural network of the present disclosure may improve the quantization precision, efficiency, and computation efficiency of the recurrent neural network.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/CN2020/110142, filed Aug. 20, 2020, which claims priority to the benefit of Chinese Patent Application Nos. 201910798228.2 filed on Aug. 27. 2019 and 201910888141.4 filed on Sep. 19, 2019 in the Chinese Intellectual Property Office, the entire contents of which are incorporated herein by reference.

### BACKGROUND

### 1. Technical Field

The present disclosure relates to the technical field of computer technology, and specifically to a method and an apparatus for adjusting quantization parameters of a recurrent neural network, and related products.

### 2. Background Art

With continuous development, artificial intelligence technology is applied in more and more extensive fields, and have been well applied in fields of image recognition, speech recognition, natural language processing and the like. However, as the complexity of the artificial intelligence algorithms increases, the data volume and data dimension of the data to be processed are constantly increasing, which pose great challenges to the data processing efficiency of computation apparatus and the storage capacity and memory access efficiency of storage apparatus.

To solve the above technical problem, traditional technology adopts fixed bit width to quantize the computation data of a recurrent neural network; in other words, the traditional technology converts the computation data represented by floating point into the computation data represented by fixed point to compress the computation data of the recurrent neural network. However, there may be great differences between different computation data in the recurrent neural network. The traditional quantization method adopts the same quantization parameters (such as the point location(s)) to quantize the whole recurrent neural network, which may lead to low precision and affect the result of data computation.

### SUMMARY

In view of this, the present disclosure provides a method and an apparatus for adjusting quantization parameters of a recurrent neural network, and related products, which may improve the quantization precision of the neural network and ensure the correctness and reliability of the computation result.

The present disclosure provides a method for adjusting the quantization parameters of a recurrent neural network, and the method includes:

obtaining a data variation range of data to be quantized; and

determining a first target iteration interval according to the data variation range of the data to be quantized to adjust quantization parameters in recurrent neural network computation according to the first target iteration interval. The first target iteration interval comprises at least one iteration, and the quantization parameters of the recurrent neural network are configured to implement quantization of the data to be quantized in the recurrent neural network computation.

The present disclosure also provides a quantization parameter adjustment apparatus of a recurrent neural network, including a memory and a processor. A computer program may be stored in the memory, and steps of any one of the above-mentioned methods may be implemented when the processor executes the computer program. Specifically, the steps below may be implemented when the computer program is executed by the processor:

obtaining a data variation range of data to be quantized; and

determining a first target iteration interval according to the data variation range of the data to be quantized to adjust quantization parameters in recurrent neural network computation according to the first target iteration interval. The first target iteration interval comprises at least one iteration, and the quantization parameters of the recurrent neural network are configured to implement quantization of the data to be quantized in the recurrent neural network computation.

The present disclosure also provides a computer readable storage medium. A computer program may be stored in the computer readable storage medium, and the steps of any-one of the above-mentioned methods may be implemented when the computer program is executed. Specifically, the steps below may be implemented when the computer program is executed:

obtaining a data variation range of data to be quantized; and

determining a first target iteration interval according to the data variation range of the data to be quantized to adjust quantization parameters in recurrent neural network computation according to the first target iteration interval. The first target iteration interval comprises at least one iteration, and the quantization parameters of the recurrent neural network are configured to implement quantization of the data to be quantized in the recurrent neural network computation.

The present disclosure further provides a quantization parameter adjustment apparatus of a recurrent neural network that includes:

an obtaining unit configured to obtain the data variation range of data to be quantized; and

an iteration interval determining unit, which is configured to determine a first target iteration interval according to the data variation range of the data to be quantized to adjust the quantization parameters of a recurrent neural network computation according to the first target iteration interval. The target iteration interval includes at least one iteration, and the quantization parameters of the recurrent neural network is configured to quantize the data to be quantized in the recurrent neural network computation.

The method and apparatus for adjusting the quantization parameters of the recurrent neural network and related products of the present disclosure obtain the data variation range of the to-be quantized data, and determine the first target iteration interval according to the data variation range of the data to be quantized, so that quantization parameters of the recurrent neural network may be adjusted according to the first target iteration interval, and quantization parameters in different computation stages of the recurrent neural network may be determined according to the data distribution characteristics of the determined data to be quantized. Compared with the traditional technology that uses the same quantization parameters for various computation data of the same recurrent neural network, the method and apparatus of the present disclosure may improve the quantization precision of the recurrent neural network and further ensure the accuracy and reliability of the computation result. Further, the quantization efficiency may be improved by determining the target iteration interval.

### BRIEF DESCRIPTION OF THE DRAWINGS

The drawings of the present disclosure are included in the specification and constitute a part of the specification. Together with the specification, the drawings illustrate exemplary embodiments, features, and aspects of the present disclosure, and are used to explain the principles of the present disclosure.

FIG. 1 shows a schematic diagram of an application environment of a quantization parameter adjustment method in an embodiment of the present disclosure;

FIG. 2 shows a schematic diagram of correspondence between data to be quantized and quantized data in an embodiment of the present disclosure;

FIG. 3 shows a schematic diagram of conversion of data to be quantized in an embodiment of the present disclosure;

FIG. 4 shows a flow chart of a quantization parameter adjustment method of a recurrent neural network in a first embodiment of the present disclosure;

FIG. 5A shows a schematic diagram of a changing tendency of data to be quantized in a computation process in an embodiment of the present disclosure;

FIG. 5B shows an unfolding schematic diagram of a recurrent neural network in an embodiment of the present disclosure;

FIG. 5C shows a cyclic schematic diagram of a recurrent neural network in an embodiment of the present disclosure;

FIG. 6 is a flow chart of a parameter adjustment method of a recurrent neural network in an embodiment of the present disclosure;

FIG. 7 is a flow chart of a determination method of a variation range of a point location(s) in an embodiment of the present disclosure;

FIG. 8 is a flow chart of a determination method of a second mean value in a first embodiment of the present disclosure;

FIG. 9 is a flow chart of a data bit width adjustment method in a first embodiment of the present disclosure;

FIG. 10 is a flow chart of a data bit width adjustment method in a second embodiment of the present disclosure;

FIG. 11 is a flow chart of a data bit width adjustment method in a third embodiment of the present disclosure;

FIG. 12 is a flow chart of a data bit width adjustment method in a fourth embodiment of the present disclosure;

FIG. 13 is a flow chart of a determination method of a second mean value in a second embodiment of the present disclosure;

FIG. 14 is a flow chart of a quantization parameter adjustment method in a second embodiment of the present disclosure;

FIG. 15 is a flow chart of adjusting quantization parameters in a quantization parameter adjustment method in an embodiment of the present disclosure;

FIG. 16 is a flow chart of a determination method of a first target iteration interval in a parameter adjustment method in another embodiment of the present disclosure;

FIG. 17 is a flow chart of a quantization parameter adjustment method in a third embodiment of the present disclosure;

FIG. 18 shows a structural diagram of a quantization parameter adjustment apparatus in an embodiment of the present disclosure;

FIG. 19 shows a structural diagram of a board card according to an embodiment of the present disclosure.

### DETAILED DESCRIPTION

Technical solutions in embodiments of the present disclosure will be described clearly and completely hereinafter with reference to the drawings in the embodiments of the present disclosure. Obviously, the embodiments to be described are merely some of but not all of embodiments of the present disclosure. All other embodiments obtained by those of ordinary skill in the art based on the embodiments of the present disclosure without creative efforts shall fall within the protection scope of the present disclosure.

It should be understood that terms such as “first” and “second” in the claims, the specification, and the drawings are used for distinguishing different objects rather than describing a specific order. It should be understood that the terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof. It should also be understood that the terms used in the specification of the present disclosure are merely for the purpose of describing particular embodiment rather than limiting the present disclosure. As being used in the specification and the claims of the disclosure, unless the context clearly indicates otherwise, the singular forms “a”, “an” and “the” are intended to include the plural forms. It should also be understood that the term “and/or” used in the specification and the claims refers to any and all possible combinations of one or more of relevant listed items and includes these combinations.

As the complexity of artificial intelligence algorithms increases, the data volume and data dimensions of to-be-processed data are constantly increasing. However, since traditional recurrent neural network algorithms usually use a floating-point number format to perform a recurrent neural network computation, the ever-increasing data volume poses great challenges to the data processing efficiency, storage capacity and memory access efficiency of the storage apparatus, and the like. In order to solve the above problem, the computation data involved in the computation process of the recurrent neural network may be quantized; in other words, the computation data. represented by floating point may be converted into computation data. represented by fixed point, thereby reducing the storage capacity and the memory access efficiency of the storage apparatus and improving the computation efficiency of the computation apparatus. However, in traditional quantization methods, a same data bit width and the same quantization parameters (such as a location of a decimal point) are used to quantize different computation data of the recurrent neural network during the entire training process of the recurrent neural network. Due to the difference among different pieces of computation data, or the difference among pieces of computation data at different stages in the training process, the quantization by using the above quantization method often lead to insufficient accuracy, which will affect the computation result.

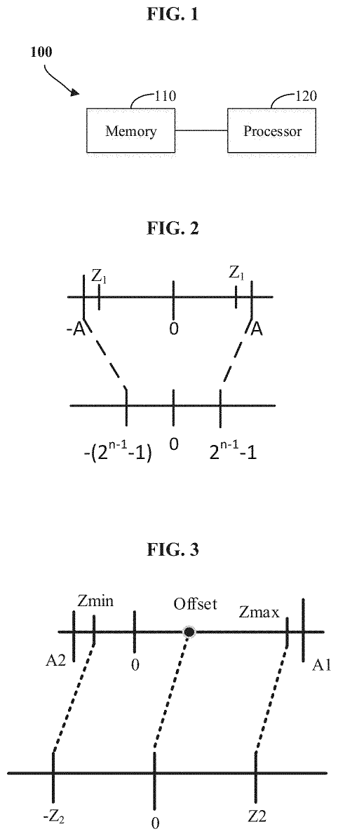

Based on this, the present disclosure provides a quantization parameter adjustment method of a recurrent neural network, which may be applied to a quantization parameter adjustment apparatus including a memory 110 and a processor 120. FIG. 1 is a structural block diagram of the quantization parameter adjustment apparatus 100. The processor 120 of the quantization parameter adjustment apparatus 100 may he a general-purpose processor or an artificial intelligence processor, or may include a general-purpose processor and an artificial intelligence processor, which is not limited here. The memory 110 may be configured to store computation data in the computation process of the recurrent neural network. The computation data may he one or more of neuron data, weight data or gradient data. The memory 110 may also be configured to store a computer program. When the processor 120 executes the computer program, the quantization parameter adjustment method in an embodiment of the present disclosure may he implemented. The method may he applied to a training or fine-tuning process of the recurrent neural network, and used to dynamically adjust the quantization parameters of the computation data according to the distribution characteristics of the computation data at different stages of the training or fine-tuning process of the recurrent neural network, and thereby improve the accuracy of the quantization of the recurrent neural network to ensure the accuracy and reliability of the computation result.

Unless otherwise specified, the artificial intelligence processor may be any appropriate hardware processor, such as a CPU (central processing unit), a GPU (graphics processing unit). an FPGA (field-programmable gate array), a DSP (digital signal processor), an ASIC (application-specific integrated circuit), and the like. Unless otherwise specified, the memory may he any suitable magnetic storage medium or magneto-optical storage medium, such as a RRAM (resistive random-access memory), a DRAM (dynamic random-access memory), an SRAM (static random-access memory), an EDRAM (enhanced dynamic random-access memory), a HBM (high-bandwidth memory), or a HMC (hybrid memory cube), and the like.

In order to better understand the present disclosure, the following first introduces the quantization process and the quantization parameters involved in the quantization process in the embodiments of the present disclosure,

In an embodiment of the present disclosure, quantization refers to converting computation data in a first data format into computation data in a second data format. The computation data in the first data format may he represented by floating point computation data, and the computation data in the second data format may be represented by fixed point. Since computation data represented by floating point usually occupies a large storage space, converting computation data represented by floating point to computation data represented by fixed point may save the storage space, and improve the accessing efficiency and computation efficiency of the computation data.

Optionally, the quantization parameters in the quantization process may include a point location(s) and/or a scale factor. The point location(s) refers to the location of the decimal point in the quantized computation data, and the scale factor refers to the ratio between the maximum value of the quantized data and the maximum absolute value of the data to be quantized. Further, the quantization parameters may also include an offset, which is for asymmetric data to be quantized and refers to an intermediate value of a plurality of elements in the data to he quantized. Specifically, the offset may be a midpoint values of a plurality of elements in the data to be quantized. When the data to be quantized is symmetrical, the quantization parameters may not include the offset. In this case, quantization parameters such as the point location(s) and/or the scale factor may be determined according to the data to be quantized.

FIG. 2 shows a schematic diagram of correspondence of data to be quantized and quantized data in an embodiment of the present disclosure. As shown in FIG. 2, the data to be quantized is data symmetric with respect to an origin. It is assumed that Z1 is the maximum absolute value of the elements of the data to be quantized, and the data bit width corresponding to the data to be quantized is n, and A is the maximum value that may be represented by the quantized data after the data to be quantized is quantized by using the data bit width n. A is the maximum value that may be represented by the quantized data after the quantized data is quantized with the data bit width n. A is 2^{s}(2ⁿ⁻¹−1) A needs to include Z1, and Z1 must be greater than

$$\frac{A}{2} .$$

Therefore, there is a constraint of formula (1):

2^{s}(2ⁿ⁻¹−1)≥Z₁>2^{s-1}(2ⁿ⁻¹−1) Formula (1).

The processor may calculate the point location s according to the maximum absolute value Z1 and the data bit width n of the data to be quantized. For example, the following formula (2) may be applied to calculate the point location s corresponding to the data to be quantized:

$$s = ceil ( {log}_{2} ( \frac{{Z}_{1}}{{2}^{n - 1} - 1} ) ) . \qquad Formula ( 2 )$$

In formula (2), ceil denotes a rounding up operation, Z1 denotes the maximum absolute value of the data to be quantized, s denotes the point location, and n denotes the data bit width.

When the point location s is used to quantize the data to be quantized, the data to be quantized represented by floating point Fₓ may be expressed as Fₓ≈Iₓ×2^{s}, where Iₓ refers to the quantized n-bit binary representation value, and s refers to the point location. In this formula, the quantized data corresponding to the data to be quantized is:

$${I}_{x} = round ( \frac{{F}_{x}}{{2}^{s}} ) . \qquad Formula ( 3 )$$

In this formula, s denotes the point location, Iₓ denotes the quantized data, Fₓ denotes the data to be quantized, round denotes a rounding off operation. It is understandable that other rounding computation methods such as rounding up, rounding down, and rounding to zero may also be used to replace the rounding off computation in the formula (3). It may be understood that, in the case of a certain data bit width, for the quantized data obtained according to the quantization of point location, the more bits after the decimal point, the greater the quantization precision of the data to be quantized will be.

Furthermore, intermediate representation data Fₓ₁ corresponding to the data to be quantized may be:

$${F}_{x 1} = round ( \frac{{F}_{x}}{{2}^{s}} ) \times {2}^{s} . \qquad Formula ( 4 )$$

In formula (4), s denotes a point location determined according. to the formula (2), Fₓ denotes the data to be quantized, round denotes a rounding off operation. Fₓ₁ may be data obtained by dequantizing the quantized data Iₓ. A data representation format of the intermediate representation data Fₓ₁ is consistent with a data representation format of the data to be quantized Fₓ, and the intermediate representation data may be used to compute the quantization error, as detailed below, where dequantization refers to the inverse process of quantization.

Optionally, the scale factor may include a first scale factor, which may be calculate according to the following formula (5):

$${f}_{1} = \frac{{Z}_{1}}{A} = \frac{{Z}_{1}}{{2}^{s} ( {2}^{n - 1} - 1 )} . \qquad Formula ( 5 )$$

In formula (5), Z1 is the maximum absolute value of the data to be quantized, and A is a maximum value that may be represented by the quantized data after quantizing the data to be quantized with the data bit width n, A is 2^{s}(2ⁿ⁻¹−1).

At this time, the processor may quantize the data to be quantized Fₓ by combining the point location and the first scale factor to obtain the quantized data,

$${I}_{x} = round ( \frac{{F}_{x}}{{2}^{s} \times {f}_{1}} ) . \qquad Formula ( 6 )$$

In formula (6), s denotes the point location determined according to the formula (2), f₁ denotes the first scale factor, Iₓ denotes the quantized data, Fₓ denotes the data to be quantized, and round denotes a rounding off operation. It is understandable that other rounding computation methods such as rounding up, rounding down, and rounding to zero may also be used to replace the rounding off computation in the formula (6).

Furthermore, the intermediate representation data Fₓ₁ corresponding to the data to be quantized may be:

$${F}_{x 1} = round ( \frac{{F}_{x}}{{2}^{s} \times {f}_{1}} ) \times {2}^{s} \times {f}_{1} . \qquad Formula ( 7 )$$

In formula (7), s denotes the point location determined according to the formula (2), f₁ denotes the scale factor, Fₓ denotes the data to be quantized, and round denotes a rounding off operation. Fₓ₁ may be data obtained by dequantizing the quantized data Iₓ. A data representation format of the intermediate representation data Fₓ₁ is consistent with a data representation format of the data to be quantized Fₓ, and the intermediate representation data Fₓ₁ may be used to compute the quantization error, as detailed below, where dequantizahon refers to the inverse process of quantization.

Optionally, the scale factor may also include a second scale factor, which may be calculated according to the following formula:

$${f}_{2} = \frac{{Z}_{1}}{( {2}^{n - 1} - 1 )} . \qquad Formula ( 8 )$$

The processor may quantize the data to be quantized Fₓ by using the second scale factor to obtain the quantized data:

$${I}_{x} = round ( \frac{{F}_{x}}{{f}_{2}} ) . \qquad Formula ( 9 )$$

In formula (9), f₂ denotes the second scale factor, Iₓ denotes the quantized data, Fₓ denotes the data to be quantized, and round denotes a rounding off operation. It is understandable that other rounding computation methods such as rounding up, rounding down, and rounding to zero may also be used to replace the rounding off computation in the formula (9). It is understandable that in the case of a certain data bit width, the numerical range of the quantized data may be adjusted by adopting different scale factors.

Furthermore, the intermediate representation data Fₓ₁ corresponding to the data to be quantized may be:

$${F}_{x 1} = round ( \frac{{F}_{x}}{{f}_{2}} ) \times {f}_{2} . \qquad Formula ( 10 )$$

In formula (10), f₂ denotes the the second scale factor, Fₓ denotes the data to be quantized, and round denotes a rounding off operation. Fₓ₁ may be data obtained by dequantizing the quantized data Iₓ. A data representation format of the intermediate representation data Fₓ₁ is consistent with a data representation format of the data to be quantized Fₓ, and the intermediate representation data Fₓ₁ may be used to compute the quantization error, as detailed below, where dequantizati on refers to the inverse process of quantization.

Furthermore, the second scale factor may be determined according to the point location and the first scale factor f₁. The second scale factor may be calculated according to the following formula:

f₂=e^{s}×f₁ Formula (11).

In formula (11), s denotes the point location determined according to the formula (2), and f₁ denotes the first scale factor obtained. according to the formula (5).

Optionally, the quantization method in the embodiment of the present disclosure may realize the quantization of both symmetric data and asymmetric data. At this point, the processor may convert asymmetric data into symmetric data to avoid data “overflow”. Specifically, the quantization parameters may also include an offset, which may be a midpoint value of the data to be quantized, and may be used to indicate the offset of the midpoint value of the data to be quantized from the origin. FIG. 3 shows a schematic diagram of conversion of data to be quantized in an embodiment of the present disclosure. As shown in FIG. 3, the processor may make statistics on the data distribution of the data to be quantized, and obtain a minimum value Zₘᵢₙ and a maximwn value Zₘₐₓ among all elements in the data to be quantized. The processor may compute the minimum value Zₘᵢₙ and the maximum value Zₘₐₓ to obtain the offset. Specifically, the offset may be calculated as follows:

$$o = \frac{{Z}_{max} + {Z}_{min}}{2} . \qquad Formula ( 12 )$$

In formula (12), o represents the offset, Zₘᵢₙ denotes the minimum value among all the elements of the data to be quantized, and Zₘₐₓ represents the maximum value among all the elements of the data. to be quantized. lid Furthermore, the processor may determine a maximum of the absolute value Z₂ in the data to be quantized according to the minimum value Zₘᵢₙ and the maximum value Zₘₐₓ in all the elements of the data to be quantized.

$${Z}_{2} = \frac{{Z}_{max} - {Z}_{min}}{2} . \qquad Formula ( 13 )$$

In this way, the processor may translate the data to be quantized according to the offset o, and convert the asymmetric data to be quantized into the symmetric data to be quantized as shown in FIG. 3. The processor may further determine the point location s according to the maximum of the absolute value Z₂ in the data to be quantized, where the point location may be computed according to the follow formula:

$$s = ceil ( {log}_{2} ( \frac{{Z}_{2}}{{2}^{n - 1} - 1} ) ) . \qquad Formula ( 14 )$$

In formula (14), ceil denotes the rounding up computation, s denotes the point location, and n denotes the data bit width.

After that, the processor may obtain the quantized data by quantizing the data to be quantized according to the offset and the corresponding position location:

$${I}_{x} = round ( \frac{{F}_{x} - o}{{2}^{s}} ) . \qquad Formula ( 15 )$$

In formula (15), s denotes the point location determined according to the formula (14), o is the offset, Iₓ denotes the quantized data, Fₓ denotes the data to be quantized, and round denotes a rounding off operation. It is understandable that other rounding computation methods such as rounding up, rounding down, and rounding to zero may also be used to replace the rounding off computation in the formula (15),

Furthermore, the intermediate representation data Fₓ₁ corresponding to the data to be quantized may be:

$${F}_{x 1} = round ( \frac{{F}_{x} - o}{{2}^{s}} ) \times {2}^{s} + o . \qquad Formula ( 16 )$$

In formula (16), s denotes the point location determined according to the formula (14), o denotes the offset, Fₓ denotes the data to he quantized, and round denotes a rounding off operation. Fₓ₁ may be data obtained by dequantizing the quantized data Iₓ. A data representation format of the intermediate representation data Fₓ₁ is consistent with a data representation format of the data to be quantized Fₓ, and the intermediate representation data Fₓ₁ may be used to compute the quantization error, as detailed below, where dequantization refers to the inverse process of quantization.

Further optionally, the processor may further determine the point location s and the first scale factor f₁ according to the maximum absolute value Z₂ in the data to be quantized, where the point location s may be computed according to the formula (14). The first scale factor f₁ may be computed according to the following formula:

$${f}_{1} = \frac{{Z}_{2}}{A} = \frac{{Z}_{2}}{{2}^{s} ( {2}^{n - 1} - 1 )} . \qquad Formula ( 17 )$$

The processor may quantize the data to be quantized according to the offset and its corresponding first scale factor f₁ and the point location s to obtain the quantized data:

$${I}_{x} = round ( \frac{{F}_{x} - o}{{2}^{s} \times {f}_{1}} ) . \qquad Formula ( 18 )$$

In formula (18), f₁ denotes the first scale factor, s denotes the point location determined according to the formula (14), o is the offset, Iₓ denotes the quantized data, Fₓ denotes the data to he quantized, and round denotes the rounding off operation. It is understandable that other rounding operation methods such as rounding up, rounding down, and rounding to zero may also be used to replace the rounding off operation in the formula (18).

Furthermore, the intermediate representation data Fₓ₁ corresponding to the data to be quantized may be:

$${F}_{x 1} = round ( \frac{{F}_{x} - o}{{2}^{s} \times {f}_{1}} ) \times {2}^{s} \times {f}_{1} + o . \qquad Formula ( 19 )$$

In formula (19), f₁ denotes the first scale factor, s denotes the point location determined according to the formula (14), o denotes the offset, Fₓ denotes the data to be quantized, and round denotes the rounding off operation. Fₓ₁ may be data obtained by dequantizing the quantized data Iₓ. A data representation format of the intermediate representation data Fₓ₁ is consistent with a data representation format of the data to be quantized Fₓ, and the intermediate representation data Fₓ₁ may be used to compute the quantization error, as detailed below where dequantization refers to the inverse process of quantization.

Optionally, the scale factor may also include a second scale factor, which may be computed according to the following formula:

$${f}_{2} = \frac{{Z}_{2}}{( {2}^{n - 1} - 1 ) .} \qquad Formula ( 20 )$$

The processor may quantize the data to be quantized Fₓ by using the second scale factor to obtain the quantized data:

$${I}_{x} = round ( \frac{{F}_{x}}{{f}_{2}} ) . \qquad Formula ( 21 )$$

where f₂ denotes the second scale factor, Iₓ denotes the quantized data, Fₓ denotes the data to be quantized, and round denotes a rounding off operation. It is understandable that other rounding operation methods such as rounding up, rounding down, and rounding to zero may also be used to replace the rounding off operation in the formula (21). It is understandable that when the data bit width is constant, different scale factors may be used to adjust the numerical range of the quantized data.

Furthermore, the intermediate representation data Fₓ₁ corresponding to the data to be quantized may be:

$${F}_{x 1} = round ( \frac{{F}_{x}}{{f}_{2}} ) \times {f}_{2} . \qquad Formula ( 22 )$$

In formula (10), f₂ denotes the the second scale factor, Fₓ denotes the data to be quantized, and round denotes a rounding off operation. Fₓ₁ may be data obtained by dequantizing the quantized data Iₓ. A data representation format of the intermediate representation data. Fₓ₁ is consistent with a data representation format of the data to be quantized F. and the intermediate representation data Fₓ₁ may be used to compute the quantization error, as detailed below, where dequantization refers to the inverse process of quantization. Furthermore, the second scale factor may be determined according to the point location and the first scale factor f₁. The second scale factor may be computed according to the following formula:

f₂=2^{s}×f₁ (23).

In formula (11), s denotes the point location determined according to the formula (14), and f₁ denotes the first scale factor obtained according to the formula (17).

Optionally, the processor may also quantize the data to be quantized according to the offset o, at which point the point location s and/or the scale factor may be preset values. At this time, the processor may quantize the data to be quantized according to the offset to obtain the quantized data:

Iₓ=round(Fₓ−o) Formula (24).

In formula (24), o denotes the offset, Iₓ denotes the quantized data, Fₓ denotes the data to be quantized, and round denotes the rounding off operation. It is understandable that other rounding operation methods such as rounding up, rounding down, and rounding to zero may also be used to replace the rounding off operation in the formula (24). It is understandable that when the data hit width is constant, different scale factors may be used to adjust the offset between the value of data after the quantization and the data before the quantization.

Furthermore, the intermediate representation data Fₓ₁ corresponding to the data to be quantized may be:

Fₓ₁=round(Fₓ−o)+o Formula (25),

In formula (25), o denotes the offset, Fₓ denotes the data to be quantized, and round denotes the rounding off operation. Fₓ₁ may be data obtained by dequantizin.g the quantized data Iₓ. A data representation format of the intermediate representation data. Fₓ₁ is consistent with a data representation format of the data to be quantized Fₓ, and the intermediate representation data Fₓ₁ may be used to compute the quantization error, as detailed below, where dequantization refers to the inverse process of quantization.

The quantization operation of the present disclosure may be used to realize the quantization of both floating-point data and fixed-point data. Optionally, the computation data in the first data format may be represented by fixed point, and the computation data in the second data format may also be represented by fixed point. The data representation range of the computation data in the second data format is less than that of the computation data in the first data format, and the decimal bits in the second data format is greater than that in the first data format. In other words, the computation data in the second data format has higher precision than the computation data in the first data format. For example, the computation data in the first data format may be floating point computation data occupying 16 bits, and the computation data in the second data format may be fixed point computation data occupying 8 bits. In an embodiment of the present disclosure, quantization processing may be performed on the computation data represented by fixed point, thereby further reducing the storage space occupied by the computation data., and improving the accessing efficiency and computation efficiency of the computation data.

The quantization parameter adjustment method of the recurrent neural network in an embodiment of the present disclosure may be applied to the training or fine-tuning process of the recurrent neural network, so as to dynamically adjust the quantization parameters of the computation data in the computation of the recurrent neural network during the training or fine-tuning process of the recurrent neural network, thereby improving the quantization precision of the recurrent neural network. The recurrent neural network may be a deep recurrent neural network or a convolutional recurrent neural network, and the like, which is not specifically limited here.

It should be clear that a training of a recurrent neural network refers to a process of performing a plurality of iteration computations on the recurrent neural network (the weight of the recurrent neural network may be a random number), so that the weight of the recurrent neural network may meet a preset condition, where an iteration generally includes a forward computation, a reverse computation, and a weight update computation. The forward computation refers to a process of forward inference based on input data of the recurrent neural network to obtain a forward computation result. The reverse computation is a process of determining a loss value according to the forward computation result and a preset reference value and determining a gradient value of the weight and/or a gradient value of the input data according to the loss value. The weight update computation refers to a process of adjusting the weight of the recurrent neural network according to the gradient value of the weight. Specifically, the training process of the recurrent neural network is as follows: the processor may use the recurrent neural network with the weight represented by a random number to perform the forward computation on the input data to obtain a forward computation result. The processor then determines the loss value according to the forward computation result and the preset reference value and determines the gradient value of the weight and/or the gradient value of the input data according to the loss value. Finally, the processor may update the gradient value of the recurrent neural network according to the gradient value of the weight and obtain a new weight to complete an iteration calculation. The processor recurrently executes a plurality of iteration computations until the forward computation result of the recurrent neural network satisfies the preset condition. For example, when the forward computation result of the recurrent neural network converges to the preset reference value, the training ends. Alternatively, when the forward computation result of the recurrent neural network and the loss value of the preset reference value are less than or equal to a preset precision, the training ends.

The fine tuning refers to a process of performing a plurality of iteration computations on the recurrent neural network (the weight of the recurrent neural network is a number already in a convergent state rather than a random number), so that the precision of the recurrent neural network may meet a preset requirement. The fine-tuning process is basically the same as the training process and may be regarded as a process of retraining the recurrent neural network that is in a convergent state, inference refers to a process of performing the forward computation by using the recurrent neural network of which the weight meets the preset condition to realize functions such as recognition or classification, for example, recognizing images by using recurrent neural network, and the like.

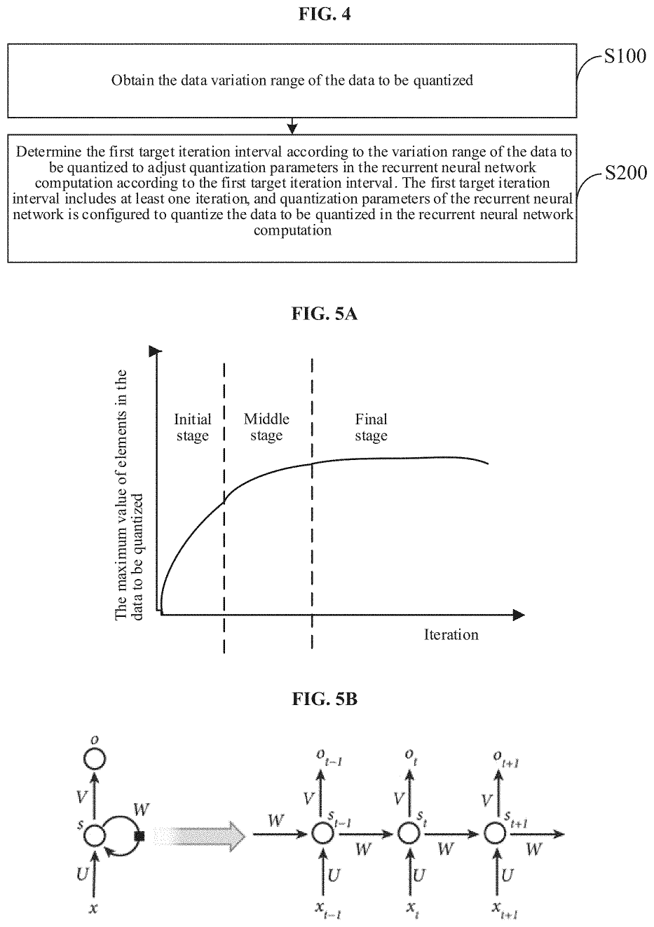

In an embodiment of the present disclosure, in the training or fine-tuning process of the recurrent neural network, different quantization parameters may be used to quantize the computation data of the recurrent neural network at different stages, and the iteration computations may be performed according to the quantized data, thereby reducing the data storage space during the recurrent neural network computation and improving the data access efficiency and the computation efficiency. FIG. 4 is a flow chart of a quantization parameter adjustment method of the recurrent neural network in an embodiment of the present disclosure. As shown in FIG. 4, the above method may include steps S100-S200.

In the step S100, a data variation range of the data to be quantized is obtained.

Optionally, the processor may directly read the data variation range of the data to be quantized. The data variation range of the data to be quantized may be input by the user.

Optionally, the processor may calculate the data variation range of the data to be quantized according to the data to be quantized in the current verify iteration and the data to be quantized in the historical iterations. The current verify iteration refers to iteration computation that is currently performed, and the historical iterations refer to the iteration computation performed before the current verify iteration. For example, the processor may obtain the maximum value and the average value of the elements in the data to be quantized in the current verify iteration, and the maximum value and the average value of the elements in the data to be quantized in each historical iteration, and then determine the variation range of the data to be quantized according to the maximum value and the average value of elements in each iteration. If the maximwn value of the elements in the data to be quantized in the current verify iteration is close to the maximum value of the elements in the data. to be quantized in the historical iterations with a preset number, and if the average value of the elements in the data to be quantized in the current verify iteration is close to the average value of the elements in the data to be quantized in the preset number of historical iterations, it may be determined that the data variation range of the data to be quantized is small. Otherwise, it may be determined that the data variation range of the data to be quantized is large. For another example, the variation range of the data to be quantized may be represented by a moving average value or a variance of the data to be quantized, and the like, which is not specifically limited here.

In an embodiment of the present disclosure, the variation range of the data to be quantized may be used to determine whether the quantization parameters of the data to be quantized need to be adjusted. For example, if the variation range of the data to be quantized is large, it means that quantization parameters need to be adjusted in time to ensure the quantization precision. If the variation range of the data to be quantized is small, the quantization parameters in the historical iterations may be used in the current verify iteration and a certain number of iterations after the current verify iteration, thereby avoiding frequent quantization parameter adjustment and improving the quantization efficiency.

Each iteration involves at least one piece of data to be quantized, the data to be quantized may be computation data represented by floating point or computation data represented by fixed point. Optionally, the data to be quantized in each iteration may be at least one of neuron data., weight data and gradient data, and the gradient data may also include neuron gradient data, weight gradient data, and the like.

In step S200, the first target iteration interval according to the variation range of the data to be quantized is determined to adjust quantization parameters in the recurrent neural network computation according to the first target iteration interval. The first target iteration interval includes at least one iteration, and quantization parameters of the recurrent neural network is configured to quantize the data to be quantized in the recurrent neural network computation.

Optionally, the quantization parameters may include the point location(s) and/or the scale factor, where the scale factor may include a first scale factor and a second scale factor. The method of calculating the point location(s) may refer to the formula (2). and the method of calculating the scale factor may refer to the formula (5) or formula (8), which will not be repeated here. Optionally, the quantization parameters may also include an offset, and the method of calculating the offset may refer to the formula (12); furthermore, the processor may also determine the point location(s) according to the formula (14) and determine the scale factor according to the formula (17) or formula (20). In an embodiment of the present disclosure, the processor may update at least one of the point location, the scale factor and the offset according to the determined target iteration interval to adjust quantization parameters in the recurrent neural network computation. In other words, quantization parameters in the recurrent neural network computation may be updated according to the variation range of the data to be quantized in the recurrent neural network computation, so that the quantization precision may be guaranteed,

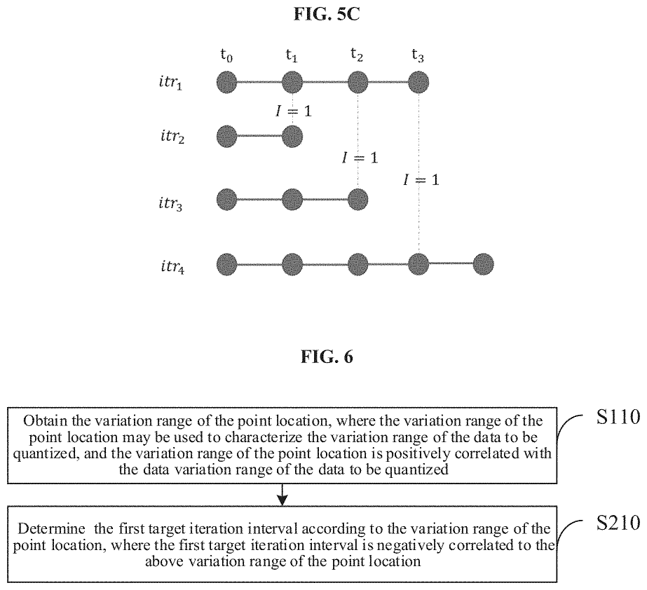

It is understandable that a data variation curve of the data to be quantized may be obtained. by performing statistics and analysis on the variation trend of the computation data during the training or fine-tuning process of the recurrent neural network. FIG. 5A shows a schematic diagram of variation tendency of data to be quantized in a computation process in an embodiment of the present disclosure. As shown in FIG. 5A, it may he seen from the data variation curve that in the initial stage of the training or fine tuning of the recurrent neural network, the data variation of data to be quantized in different iterations is relatively drastic, and as the training or fine tuning computation progresses, the data variation of the data to be quantized in different iterations gradually tends to be gentle. Therefore, in the initial stage of the training or fine tuning of the recurrent neural network, quantization parameters may be adjusted frequently; in middle and late stages of the training or fine tuning of the recurrent neural network, quantization parameters may be adjusted at intervals of a plurality of iterations or cycles. The method of the present disclosure is to determine a suitable iteration interval to achieve a balance between quantization precision and quantization efficiency.

Specifically, the processor may determine the first target iteration interval according to the variation range of the data to be quantized to adjust quantization parameters in the recurrent neural network according to the first target iteration interval. Optionally, the first target iteration interval may increase as the variation range of the data to be quantized decreases. In other words, when the variation range of the data to be quantized is larger, the first target iteration interval is smaller, which indicates that the adjustment of quantization parameters is more frequent. When the variation range of the data to be quantized is smaller, the first target iteration interval is greater, which indicates that the adjustment of quantization parameters is adjusted less frequent. Of course, in other embodiments, the first target iteration interval may be a hyperparameter. For example, the first target iteration interval may be customized by the user.

Optionally, various data to be quantized, such as the weight data, the neuron data and the gradient data may have different iteration intervals, Correspondingly, the processor may respectively obtain the variation ranges corresponding to the various data to be quantized, so as to determine the first target iteration intervals corresponding to the respective types of data to be quantized according to the variation range of each type of data to be quantized. In other words, the quantization process of various types of data to be quantized may be performed asynchronously. In an embodiment of the present disclosure, due to the difference among different types of data to be quantized, the variation ranges of different data to be quantized may be used to determine the corresponding first target iteration intervals, and then determine the corresponding quantization parameters according to the corresponding first target iteration intervals, so that the quantization precision of the data to be quantized may be guaranteed, and the correctness of the computation result of the recurrent neural network may be ensured,

Of course, in other embodiments, the same target iteration interval (including any one of the first target iteration interval, the preset iteration interval, and the second target iteration interval) may be determined for different types of data to be quantized, so as to adjust the quantization parameters corresponding to the data to be quantized according to the target iteration interval. For example, the processor may respectively obtain the variation range of the various type of data to be quantized and determine the target iteration interval according to the largest variation range of the data to be quantized, and respectively determine the quantization parameters of the various data to be quantized according to the target iteration interval. Further, different types of data to be quantized may use the same quantization parameters.

Further optionally, the recurrent neural network may include at least one computation layer, and the data to be quantized may be at least one of neuron data, weight data, and gradient data involved in each computation layer. At this time, the processor may obtain the data to be quantized involved in the current computation layer and determine the variation ranges of various data to be quantized in the current computation layer and the corresponding first target iteration intervals according to the above method.

Optionally, the processor may determine the variation range of the data to be quantized once in each iteration computation process and determine the first target iteration interval once according to the variation range of the corresponding data to be quantized. In other words, the processor may calculate the first target iteration interval once in each iteration. The specific method of calculating the first target iteration interval may be seen in the description below. Further, the processor may select the verify iteration from each iteration according to the preset condition and determine the variation range of the data to be quantized at each verify iteration, and update and adjust quantization parameters and the like according to the first target iteration interval corresponding to the verify iteration. At this time, if the verify iteration is not the selected verify iteration, the processor ma ignore the first target iteration interval corresponding to the iteration.

Optionally, each target iteration interval may correspond to one verify iteration, which may be the starting iteration of the target iteration interval or the ending iteration of the target iteration interval. The processor may adjust quantization parameters of the recurrent neural network at the verify iteration of each target iteration interval, to adjust quantization parameters of the recurrent neural network according to the target iteration interval. The verify iteration may be the point in time for verifying whether the current quantization parameters meets the requirement of the data to be quantized. The quantization parameters before the adjustment may be the same as the quantization parameters after the adjustment or may be different from the quantization parameters after the adjustment. Optionally, the interval between adjacent verify iterations may be greater than or equal to the target iteration interval,

For example, the target iteration interval may calculate the number of iterations from the current verify iteration, which may be the starting iteration of the target iteration interval. For example, if the current verify iteration is the 100th iteration, the processor may determine the target iteration interval as 3 according to the variation range of the data to be quantized, and the processor may determine that the target iteration interval includes 3 iterations, which are respectively the 100th iteration, the 101st iteration, and the 102nd iteration. The processor may adjust the quantization parameters in the recurrent neural network computation at the 100th iteration, where the current verify iteration is the corresponding iteration computation when the processor is currently performing the update and adjustment of the quantization parameters,

Optionally, the target iteration interval may calculate the number of iterations from the next iteration of the current verify iteration, and the current verify iteration may be the ending iteration of the iteration interval before the current verify iteration. For example, if the current verify iteration is the 100th iteration, the processor may determine the target iteration interval as 3 according to the variation range of the data to be quantized, and the processor may determine that the target iteration interval includes 3 iterations, which are respectively the 101st iteration, the 102nd iteration, and the 103rd iteration. The processor may adjust quantization parameters in the recurrent neural network computation at the 100th iteration and the 103rd iteration. The method for determining the target iteration interval is not limited here.

FIG. 5B shows an unfolding schematic diagram of a recurrent neural network in an embodiment of the present disclosure. As shown in FIG. 5B, the unfolding schematic diagram of a hidden layer of the recurrent neural network is provided, where t−1, t, and t+1 represent time series. X represents an input sample. St represents a memory of the sample at time t, St=f(W*St−1+U*Xt) represents an input weight, U represents a weight of the input sample at time t, and V represents a weight of an output sample. Due to the different number of layers unfolded by different recurrent neural networks, the total number of iterations contained in different cycles is different when the quantization parameters are updated. FIG. 5C shows a schematic diagram of a recurrent neural network in an embodiment of the present disclosure. As shown in FIG. 5C, iter₁, iter₂, iter₃, and iter₄ are four cycles of the recurrent neural network, where the first cycle iter₁ includes four iterations, which are t₀, t₁, t₂, and t₃. The second cycle iter₂ includes two iterations, which are t₀, and t₁. The third cycle iter₃ includes three iterations, which are t₀, t₁, and t₂. The fourth cycle iter₂ includes five iterations, which are t₀, t₁, t₂, t₃, and t₄. In the calculation of the time when the recurrent neural network may update the quantization parameters, the total number of iterations in different cycles needs to be used.

In an embodiment, it may be seen from the calculation formula of the point location, the scale factor, and the offset that the quantization parameters are usually related to the data to be quantized, Therefore, in the step S100, the variation range of the data to be quantized may be determined indirectly by the variation range of the quantization parameters, and the variation range of the data to be quantized may be characterized by the variation range of the quantization parameters. Specifically, FIG. 6 is a flow chart of a parameter adjustment method of a recurrent neural network in an embodiment of the present disclosure. As shown in FIG. 6, the step S100 may include the step S110, and the step S200 may include the step S210 (seen in the description below)

In the step S110: the variation range of the point location is obtained, where the variation range of the point location may be used to characterize the variation range of the data to be quantized, and the variation range of the point location is positively correlated with the data variation range of the data to be quantized.

Optionally, the variation range of the point location may indirectly reflect the variation range of the data to be quantized. The variation range of the point location may be determined according to the point location of the current verily iteration and the point location(s) of at least one historical iteration. The point location of the current verify iteration and the point location(s) of the respective historical iterations may be determined according to formula (2). Of course, the point location of the current verify iteration and the point location(s) of the respective historical iterations may also be determined according to the formula (14).

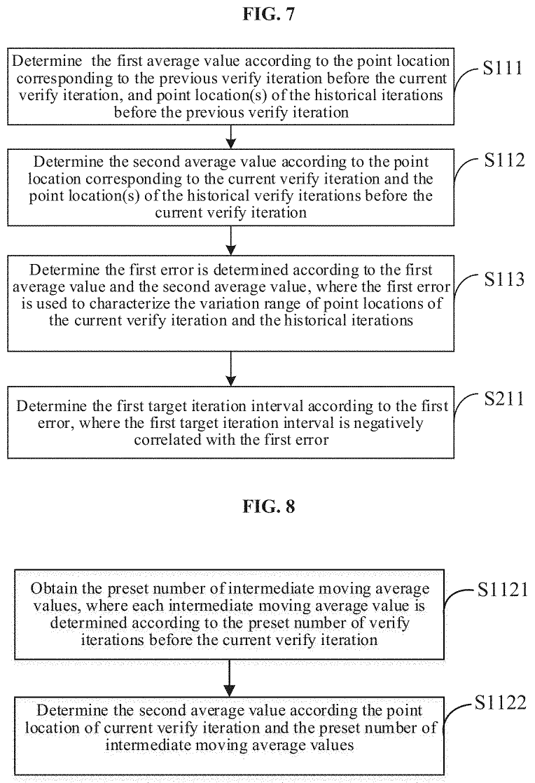

For example, the processor may calculate the variance between the point location of the current the verify iteration and the point location(s) of the historical iterations and determine the variation range of the point location according to the variance. For another example, the processor may determine the variation range of the point location according to the average value of the point location of the current verify iteration and the point location(s) of the historical iterations, Specifically, as shown in FIG. 7, the step S110 may include steps S111 to S113, and the step S210 may include the step S211 (seen the description below).

In the step S111: the first average value is determined according to the point location corresponding to a previous verify iteration before the current verify iteration, and point location.(s) of the historical iterations before the previous verify iteration. The previous verify iteration is the iteration when the quantization parameter is adjusted the last time, and there is at least one iteration interval between the previous verify iteration and the current verify iteration.

Optionally, at least one historical iteration may belong to at least one iteration interval, and each iteration interval may correspond to one verify iteration, and two adjacent verify iterations may have one iteration interval. The previous verify iteration in the step S111 may be the verify iteration corresponding to the previous iteration interval before the target iteration interval.

Optionally, the first average value may be calculated according to the following formula:

M1=a1×s^{t-1}+a2×s^{t-2}+a3×s^{t-3}+ . . . +am×s¹ Formula (26).

In formula (26). a1˜am denote the computation weights corresponding to the point locations of respective iterations, s^{t-1} denotes the point location corresponding to the previous verify iteration, s^{t-2}, s^{t-3} . . . s¹ denote the point locations corresponding to the historical iterations before the previous verify iteration, and M1 denotes the first average value. Further, according to the distribution characteristics, the farther the historical iteration is from the previous verify iteration, the smaller the influence on the distribution and variation range of the point location near the previous verify iteration. Therefore, the calculation weights may be sequentially reduced in the order of a1˜am.

For example, the previous verify iteration is the 100th iteration of the recurrent neural network operation, and the historical iterations may be the 1st iteration to the 99th iteration, and the processor may obtain the point location of the 100th iteration (i.e., s^{t-1}), and obtain the point locations of the historical iterations before the 100th iteration. In other words, s may refer to the point location corresponding to the 1st iteration of the recurrent neural network . . . , s^{t-3} may refer to the point location corresponding to the 98th iteration of the recurrent neural network, and s^{t-2} may refer to the point location corresponding to the 99th iteration of the recurrent neural network. Further, the processor may obtain the first average value according to the above formula.

Furthermore, the first average value may be calculated according to the point location(s) of the verify iteration corresponding to each iteration interval. For example, the first average value may be calculated according to the following formula:

M1=a1×s^{t-1}+a2×s^{t-2}+a3×s^{t-3}+ . . . +am×s¹.

In this formula, al-am denote the computation weights corresponding to the point locations of respective verify iterations, s^{t-1} denotes the point location corresponding to the previous verify iteration, s^{t-2}, s⁻³ . . . s¹ denote the point locations corresponding to verify iterations of a preset number of iteration intervals before the previous verify iteration, and M1 denotes the first average value.

For example, the previous verify iteration is the 100th iteration of the recurrent neural network computation, and the historical iterations may be the 1st iteration to the 99th iteration, Where the 99th iteration may belong to 11 iteration intervals. For example, the 1st iteration to the 9th iteration belong to the 1st iteration interval, the 10th iteration to the 18th iteration belong to the 2nd iteration interval, . . . , and the 90th iteration to the 99th iteration belong to the 11th iteration interval. The processor may obtain the point location of the 100th iteration (i.e., s^{t-1}) and obtain the point location of the verify iteration in the iteration interval before the 100th iteration. In other words, s¹ may refer to the point location corresponding to the verify iteration of the 1st iteration interval of the recurrent neural network (for example, s¹ may refer to the point location corresponding to the 1st iteration of the recurrent neural network), . . . , s^{t-3} may refer to the point location corresponding to the verify iteration of the 10th iteration interval of the recurrent neural network (for example, s^{t-3} may refer to the point location corresponding to the 81th iteration of the recurrent neural network), and s^{t-2} may refer to the point location corresponding to the verify iteration of the 11th iteration interval of the recurrent neural network (for example, s^{t-2} may refer to the point location corresponding to the 90th iteration of the recurrent neural network). Further, the processor may obtain the first average value M1 according to the above formula.

In an embodiment of the present disclosure, for the convenience of illustration, it is assumed that the iteration intervals include the same number of iterations. However, in actual use, as shown in FIG. 5C, the iteration intervals of the recurrent neural network include different numbers of iterations. Optionally, the number of iterations included in the iteration intervals increases with the increase of iterations; in other words, as the training or fine tuning of the recurrent neural network proceeds, the iteration intervals may become larger and larger. Furthermore, in order to simplify the computation and reduce the storage space occupied by the data, the first average value MI may he computed according to the following formula:

M1=α×s^{t-1}+(1−α)×M0 Formula (27).

In formula (27), α refers to the computation weight of the point location corresponding to the previous verify iteration, s^{t-1} refers to the point location corresponding to the previous verify iteration, and M0 refers to the moving average value corresponding to the verify iteration before the previous verify iteration, where the method for computing M0 may refer to the method for computing M1, which will not be repeated here.

In the step S112: a second average value is determined according to a point location corresponding to the current verify iteration and the point location(s) of the historical verity iterations before the current verify iteration. The point location corresponding to the current verify iteration may be determined according to the target data bit width of the current verify iteration and the data to be quantized.

Optionally, the second average value M2 may be calculated according to the following formula:

M2=b1×s^{t}+b2×s^{t-1}+b3×s^{t-2}+ . . . +bm×s¹ Formula (28).

In formula (28), 1˜bm denote the computation weights corresponding to the point locations of respective iterations, s^{t} denotes the point location corresponding to the previous verify iteration, s^{t-1}, s^{t-2} . . . s¹ denote the point locations corresponding to the historical iterations before the current verify iteration, and M2 denotes the second average value. Further, according to the distribution characteristics, the farther the historical iteration is from the current verify iteration, the smaller the influence on the distribution and variation range of the point location near the current verify iteration. Therefore, the calculation weights may be sequentially reduced in the order of b1˜bm.

For example, the current verify iteration is the 101st iteration of the recurrent neural network computation, and the historical iterations before the current verify iteration refer to the 1st iteration to the 100th iteration. The processor may obtain the point location of the 101st iteration (i.e., s^{t}), and obtain the point locations of the historical iterations before the 101st iteration, in other words, s¹ may refer to the point location corresponding to the 1st iteration of the recurrent neural network . . . . s^{t-2} may refer to the point location corresponding to the 99th iteration of the recurrent neural network, and s^{t-1} may refer to the point location corresponding to the 100th iteration of the recurrent neural network. Further, the processor may obtain the second average value M2 according to the above formula.

Optionally, the second average value may be computed according to the point location of the verify iteration corresponding to each iteration interval. Specifically, FIG. 8 is a flow chart of a determination method of a second mean value in an embodiment of the present disclosure. As shown in FIG. 8, the step S112 may include:

In the step S1121: the preset number of intermediate moving average values is obtained, where each intermediate moving average value is determined according to the preset number of verify iterations before the current verify iteration, and the verify iteration is the iteration when adjusting the parameters in the neural network quantization process

In the step S1122: the second average value is determined according the point location of current verify iteration and the preset number of intermediate moving average values.

For example, the second average value may be calculated according to the following formula:

M2=b1×s^{t}+b2×s^{t-1}+b3×s^{t-2}+ . . . +bm×s¹

In this formula, b1˜bm denote the computation weights corresponding to the point locations of respective iterations, s^{t} denotes the point location corresponding to the previous verify iteration, s^{t-1}, s^{t-2} . . . s¹ denote the point locations corresponding to the verify iterations before the current verify iteration, and M2 denotes the second average value.

For example, the current verify iteration is the 100th iteration, and the historical iterations may be the 1st iteration to the 99th iteration, where the 99th iteration may belong to 11 iteration intervals. For example, the 1st iteration to the 9th iteration belong to the 1st iteration interval, the 10th iteration to the 18th iteration belong to the 2nd iteration interval, . . . , and the 90th iteration to the 99th iteration belong to the 11th iteration interval. The processor may obtain the point location of the 100th iteration (i.e., s^{t}) and obtain the point location of the verify iteration in the iteration interval before the 100th iteration. In other words, s¹ may refer to the point location corresponding to the verify iteration of the 1st iteration interval of the recurrent neural network (for example, s¹ may refer to the point location corresponding to the 1st iteration of the recurrent neural network), . . . , s^{t-2} may refer to the point location corresponding to the verify iteration of the 10th iteration interval of the recurrent neural network (for example, s^{t-2} may refer to the point location corresponding to the 81st iteration of the recurrent neural network), and s^{t-1} may refer to the point location corresponding to the verify iteration of the 11th iteration interval of the recurrent neural network (for example, s^{t-1} may refer to the point location corresponding to the 90th iteration of the recurrent neural network). Further, the processor may obtain the second average value M2 according to the above formula.

In an embodiment of the present disclosure, for the convenience of illustration, it is assumed that the iteration intervals include the same number of iterations. However, in actual use, the iteration interval may include different numbers of iterations. Optionally, the number of iterations included in the iteration intervals increases with the increase of iterations; in other words, as the training or fine tuning of the recurrent neural network proceeds, the iteration intervals may become larger and larger.

Furthermore, in order to simplify the computation and reduce the storage space occupied by the data, the processor determine the second average value according to the point location corresponding to the current verify iteration and the first average value. In other words, the second average value may be calculated according to the following formula:

M2=β×s^{t}+(1−β)×M1 Formula (29).

In formula (29), β denotes the computation weight of the point location corresponding to the current verify iteration, and M1 denotes the first average value.

In the step S113: a first error is determined according to the first average value and the second average value, where the first error is used to characterize the variation range of point locations of the current verify iteration and the historical iterations.

Optionally, the first error may be equal to the absolute value of the difference between the second average value and the first average value. Optionally, the first error may be calculated according to the following formula:

diff_{update1}=|M2−M1|=β|s^{(t)}−M1| Formula (30).

Optionally, the point location of the current verify iteration may be determined according to the data to be quantized of the current verify iteration and the target data bit width corresponding to the current verify iteration. The specific method for calculating the point location may refer to the formula (2) or the formula (14). The target data bit width corresponding to the current verify iteration may be a hyperparameter. Further optionally, the target data bit width corresponding to the current verify iteration may be user-defined. Optionally, the data bit width corresponding to the data to he quantized in the training or fine-tuning process of the recurrent neural network may be constant; in other words, the same type of data to be quantized in the same recurrent neural network is quantized with the same data bit width. For example, the neuron data in each iteration of the recurrent neural network is quantized with a data. width of 8 bits.

Optionally, the data bit width corresponding to the data to be quantized in the training or fine-tuning process of the recurrent neural network is variable to ensure that the data bit width may meet the quantization requirements of the data to be quantized. In other words, the processor may adaptively adjust the data bit width corresponding, to the data to be quantized according to the data to he quantized to obtain the target data bit width corresponding to the data to be quantized. Specifically, the processor may first determine the target data bit width corresponding to the current verify iteration, and then the processor may determine the point location of the current verify iteration according to the target data bit width and the data to be quantized corresponding to the current verify iteration.

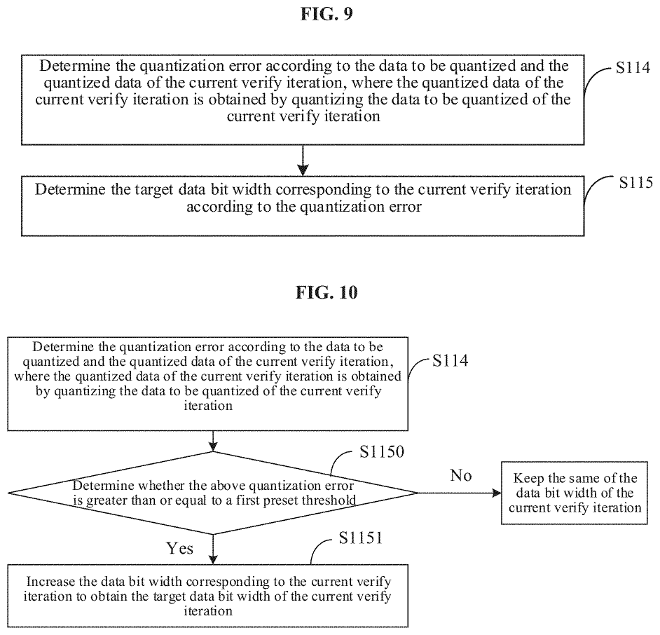

FIG. 9 is a flow chart of a data bit width adjustment method in a first embodiment of the present disclosure. As shown in FIG. 9, the step S110 may include the following steps:

In the step S114, the quantization error is determined according to the data to be quantized and the quantized data of the current verify iteration, where the quantized data of the current verify iteration is obtained by quantizing the data to be quantized of the current verify iteration.

Alternatively, the processor may quantize the data to be quantized by using the initial data bit width to obtain the quantized data. The initial data hit width of the current verify iteration may he a hyperparameter and may also be determined according to the data to be quantized of the previous verify iteration before the current verify iteration.

Specifically, the processor may determine the intermediate presentation data according to the data to be quantized and the quantized data of the current verify iteration. Optionally, the intermediate presentation data is consistent with the presentation format of the data to be quantized. For example, the processor may perform an inverse quantization on the quantized data to obtain the intermediate presentation data that is consistent with the presentation format of the data to be quantized, where the inverse quantization refers to the inverse process of quantization, For example, the quantized data may be obtained according to the formula (3). The processor may also implement inverse quantization to the quantized data according to the formula (4) to obtain the corresponding intermediate presentation data and determine the quantization error according to the data to be quantized and the intermediate presentation data.

Furthermore, the processor may calculate the quantization error according to the data to be quantized and the corresponding intermediate presentation data. Suppose the data to be quantized in the current verify iteration is Fₓ=[z₁, z₂ . . . , zₘ], and the intermediate presentation data corresponding to the data to be quantized is Fₓ₁=[z₁⁽ⁿ⁾, z₂⁽ⁿ⁾ . . . , zₘ⁽ⁿ⁾]. The processor may determine the error term according to the data to be quantized Fₓ and its corresponding intermediate presentation data Fₓ₁, and determine the quantization error according to the error term.

Optionally, the processor may determine the above-mentioned error term based on the sum of elements in the intermediate presentation dataFₓ₁ and the sum of elements in the data to be quantizedFₓ. The error term may be the difference between the sum of elements in the intermediate presentation dataFₓ₁and the sum of the elements in the data to be quantizedFₓ. After that, the processor may determine the quantization error according to the error term. The specific quantization error may be determined according to the following formula:

$${diff}_{bit} = {log}_{2} ( \frac{{\sum }_{i} \vert {z}_{i}^{( n )} \vert - {\sum }_{i} \vert {z}_{i} \vert}{{\sum }_{i} \vert {z}_{i} \vert} + 1 ) . \qquad Formula ( 31 )$$

In this formula, zᵢis the element in the data to be quantized, andzᵢ⁽ⁿ⁾is the element in the intermediate presentation dataFₓ₁.

Optionally, the processor may respectively calculate differences between each element in the data to be quantized and corresponding elements in the intermediate presentation dataFₓ₁to obtain m number of different values, and use the sum of the m number different values as the error term. After that, the processor may determine the quantization error according to the error term. The specific quantization error may be determined according to the following formula:

$${diff}_{bit} = {log}_{2} ( \frac{{\sum }_{i} \vert {z}_{i}^{( n )} - {z}_{i} \vert}{{\sum }_{i} \vert {z}_{i} \vert} + 1 ) . \qquad Formula ( 32 )$$

In this formula, zᵢis the element in the data to be quantized, andzᵢ⁽ⁿ⁾is the element in the intermediate presentation dataFₓ₁.

Optionally, the difference between each element in the data to be quantized and the corresponding element in the intermediate presentation dataFₓ₁may be approximately equal to2^{s-1}. Therefore, the quantization error may also be determined according to the following formula:

$$\text{?} \qquad Formula ( 33 )$$

$$\text{?} \text{indicates text missing or illegible when filed}$$

In formula (33), m is the number of intermediate presentation dataFₓ₁corresponding to the target data, and s is the point location, andzᵢis the element in the data to be quantized.

Optionally, the intermediate presentation data may also be consistent with the data presentation format of the quantized data, and the quantization error is determined based on the intermediate presentation data and the quantized data. For example, the data to be quantized may be expressed as: Fₓ≈Iₓ×2^{s}, then the intermediate presentation data

$${I}_{x 1} \approx \frac{{F}_{x}}{{2}^{s}}$$

may be determined, and the intermediate presentation data Iₓ₁ may have the same data presentation format as the above quantized data. At this time, the processor may determine the quantization error according to

$${I}_{x} = round ( \frac{{F}_{x}}{{2}^{s}} ) ,$$

which is calculated according to the intermediate presentation data Iₓ₁ and the above formula (3). The specific method of determining the quantization error may refer to formula (31) to formula (33).

In the step S115, the target data bit width is determined corresponding to the current verify iteration according to the quantization error.

Specifically, the processor may adaptively adjust the data bit width corresponding to the current verify iteration according to the quantization error to determine the adjusted target data bit width of the current verify iteration. When the quantization error meets the preset condition, the data bit width corresponding to the current verify iteration may keep the same; in other words, the target data bit width of the current verify iteration may be equal to the initial data bit width. When the quantization error does not meet the preset condition, the processor man adjust the data bit width corresponding to the data to be quantized in the current verify iteration to obtain the target data bit width corresponding to the current verify iteration. When the processor uses the target data bit width to quantize the data to be quantized in the current verify iteration, the quantization error meets the above-mentioned preset condition. Optionally, the above preset condition may be a preset threshold set by the user.

Optionally, FIG. 10 shows a flowchart of a data bit width adjustment method in another embodiment of the present disclosure. As shown in FIG. 10, the step S115 may include the following steps:

In the step S1150, the processor may determine whether the above quantization error is greater than or equal to a first preset threshold.

If the quantization error is greater than or equal to the first preset threshold, the step S1151 may he performed to increase the data bit width corresponding to the current verify iteration to obtain the target data bit width of the current verify iteration. When the quantization error is less than the first preset threshold, the data bit width of the current verify iteration may keep the same.

Further optionally, the processor may obtain the above-mentioned target data bit width after one adjustment. For example, when the initial data bit width of the current verify iteration is n1, the processor may determine the target data bit width n2=n1+t after one adjustment, where t is the adjusted value of the data bit width. When the target data bit width n2 is used to quantize the data to be quantized of the current verify iteration, the obtained quantization error may he less than the first preset threshold.

Further optionally, the processor may adjust a plurality of times until the quantization error is less than the first preset threshold and use the data bit width as the target data bit width when the quantization error is less than the first preset threshold. Specifically, if the quantization error is greater than or equal to the first preset threshold, the first intermediate data hit width is determined according to the first preset bit width stride: then the processor may quantize the data to be quantized of the current verify iteration according to the first intermediate data bit width to obtain the quantized data and determine the quantization error according to the data to be quantized and quantized data of the current verify iteration until the quantization error is less than the first preset threshold. The processor may use the corresponding data bit width when the quantization error is less than the first preset threshold value as the target data hit width.

For example, when the initial data bit width of the current verify iteration is n1, the processor may use the initial data bit width n1 to quantize the data to be quantized A of the current verify iteration to obtain the quantized data B1 and obtain the quantization error C1 through calculation of the data to be quantized A and the quantized data B1. When the quantization error C1 is greater than or equal to the first preset threshold, the processor may determine the first intermediate data bit width n2=n1+t1, where t1 is the first preset bit width stride. After that, the processor may quantize the data to be quantized in the current verify iteration according to the first intermediate data bit width n2 to obtain the quantized data B2 of the current verify iteration and calculate the quantization error C2 according to the data to be quantized A and the quantized data B2. If the quantization error C2 is greater than or equal to the first preset threshold, the processor may determine the first intermediate data bit width n2=n1+t1+t1 and quantize the data to be quantized A of the current verify iteration according to the new first intermediate data bit width, and then calculate the corresponding quantization error until the quantization error is less than the first preset threshold. When the quantization error C1 is less than the first preset threshold, the data hit width of the initial data may keep the same.

Furthermore, the above-mentioned first preset bit width stride may be a constant value. For example, whenever the quantization error is greater than the first preset threshold value, the processor may increase the data bit width corresponding to the current verify iteration by the same value. Optionally, the above-mentioned first preset bit width stride may also be a variable value. For example, the processor may calculate the difference between the quantization error and the first preset threshold, and the smaller the difference, the smaller the value of the first preset bit width stride.

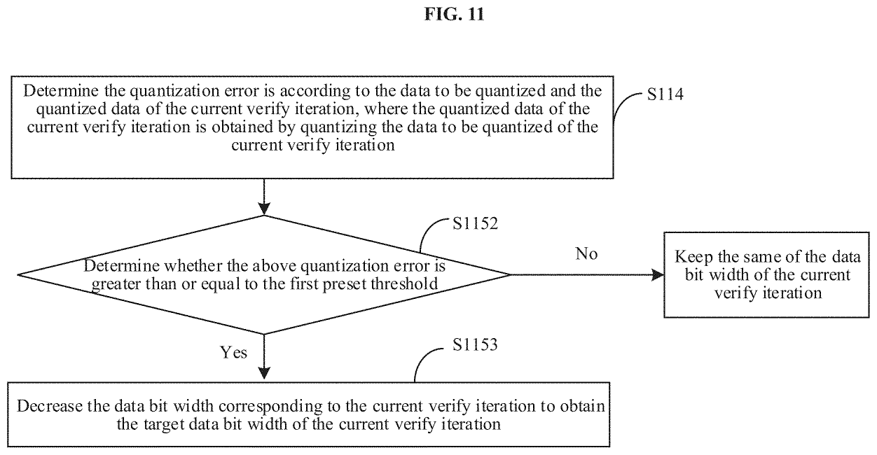

Optionally, FIG. 11 shows a flowchart of a data hit width adjustment method in another embodiment of the present disclosure. As shown in FIG. 11, the step S115 may further include the following steps:

In the step S1152, the processor may determine whether the above quantization error is greater than or equal to the first preset threshold.

If the quantization error is smaller than or equal to the first preset threshold, the step S1153 may be performed to decrease the data. bit width corresponding to the current verify iteration to obtain the target data bit width of the current verify iteration. When the quantization error is greater than the second preset threshold, the data bit width of the current verify iteration may keep the same.

Further optionally, the processor may obtain the above-mentioned target data bit width after one adjustment. For example, when the initial data bit width of the current verify iteration is ni, the processor may determine the target data bit width n2=n1−t after one adjustment, where t is the adjusted value of the data bit width. When the target data hit width n2 is used to quantize the data to be quantized of the current verify iteration, the obtained quantization error may be greater than the second preset threshold.

Further optionally, the processor may adjust a plurality of times until the quantization error is larger than the second preset threshold and use the data bit width as the target data hit width when the quantization error is greater than the first preset threshold. Specifically, if the quantization error is less than or equal to the first preset threshold, the second intermediate data bit width is determined according to the second preset bit width stride; then the processor may quantize the data to be quantized of the current verify iteration according to the second intermediate data bit width to obtain the quantized data and determine the quantization error according to the data to he quantized and quantized data of the current verify iteration until the quantization error is greater than the second preset threshold. The processor may use the corresponding data bit width when the quantization error is greater than the second preset threshold value as the target data bit width.

For example, when the initial data bit width of the current verify iteration is n1, the processor may use the initial data bit width n1 to quantize the data to be quantized A of the current verify iteration to obtain the quantized data B1 and obtain the quantization error C1 through calculation of the data to be quantized A and the quantized data B1. When the quantization error C1 is less than or equal to the second preset threshold, the processor determines the second intermediate data bit width n2=n1−t2, where t2 is the second preset bit width stride. After that, the processor may quantize the data to be quantized in the current verify iteration according to the second intermediate data bit width n2 to obtain the quantized data B2 of the current verify iteration and calculate to obtain the quantization error C2 according to the data to be quantized A and the quantized data B2. If the quantization error C2 is less than or equal to the second preset threshold, the processor may determine the second intermediate data bit width n2=n1+t2+t2 and quantize the data to be quantized A of the current verify iteration according to the new second intermediate data bit width, and then calculate the corresponding quantization error until the quantization error is greater than the second preset threshold. When the quantization error C1 is greater than the second preset threshold, the data bit width n1 of the initial data may keep the same.

Furthermore, the above mentioned second preset bit width stride may be a constant value. For example, whenever the quantization error is less than the second preset threshold value, the processor may decrease the data bit width corresponding to the current verify iteration by the same value. Optionally, the above second preset bit width stride may also be a variable value. For example, the processor may calculate the difference between the quantization error and the second preset threshold, and the smaller the difference, the smaller the value of the second preset bit width stride.

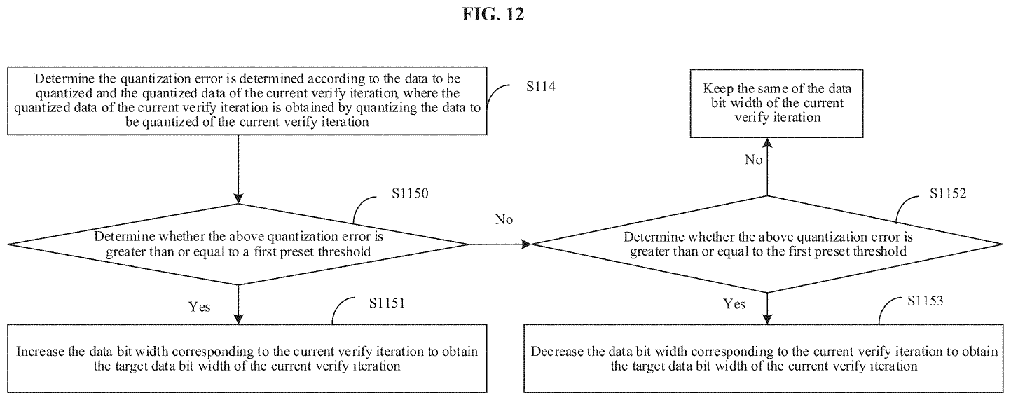

Optionally, FIG. 12 shows a flowchart of a data bit width adjustment method in another embodiment of the present disclosure. As shown in FIG. 12, when the processor determines that the quantization error is less than the first preset threshold, and the quantization error is greater than the second preset threshold, the data bit width of the current verify iteration may keep the same, where the first preset threshold is greater than the second preset threshold. In other words, the target data bit width of the current verify iteration may be equal to the initial data bit width. FIG. 12 only illustrates the data bit width determination method of an embodiment of the present disclosure by way of example, and the sequence of each operation in FIG. 12 may be adjusted adaptively, which is not specifically limited here.

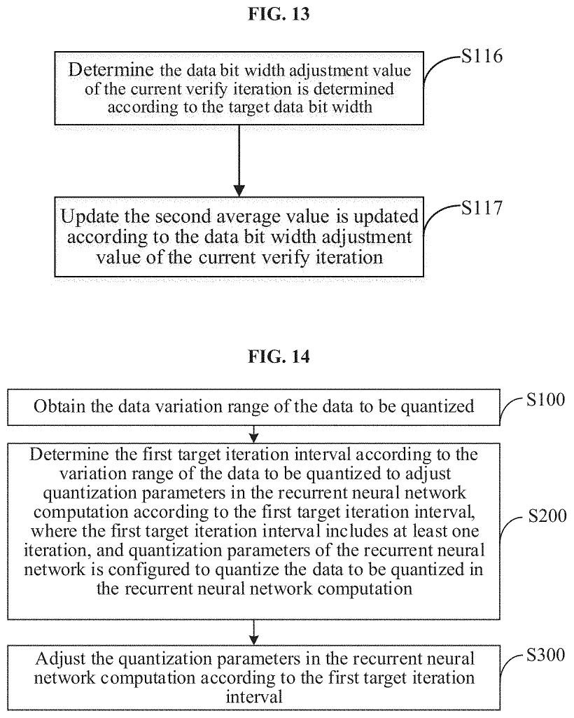

In the embodiment of the present disclosure, when the data bit width of the current verify iteration changes, the location of the point may change accordingly. However, the change of the point location at this time is not caused by the data, change of the data to be quantized. The target iteration interval obtained through calculation of the first error determined according to the above formula (30) may be inaccurate, which may affect the quantization precision. Therefore, when the data bit width of the current verify iteration changes, the above-mentioned second average value may be adjusted accordingly to ensure that the first error may accurately reflect the variation range of the point location, thereby ensuring the accuracy and reliability of the target iteration interval. Specifically, FIG. 13 is a flow chart of a determination method of a second mean value in an embodiment of the present disclosure. As shown in FIG. 13, the method may further include the following steps:

In the step S116, the data bit width adjustment value of the current verify iteration is determined according to the target data bit width;

specifically, the processor may determine the data bit width adjustment value of the current verify iteration according to the target data bit width and the initial data bit width of the current verify iteration, where the data bit width adjustment value is equal to the target data bit width minus the initial data bit width. Of course, the processor may also directly obtain the data bit width adjustment value of the current verify iteration.

In the step 117, the second average value is updated according to the data bit width adjustment value of the current verify iteration.

Specifically, if the data bit width adjustment value is greater than the preset parameter (for example, the preset parameter may be equal to zero); in other words, when the data bit width of the current verify iteration increases, the processor may decrease the second average value accordingly. If the data bit width adjustment value is less than the preset parameter (for example, the preset parameter may be equal to zero); in other words, when the data bit width of the current verify iteration decreases, the processor may increase the second average value accordingly. If the data bit width adjustment value is equal to the preset parameter; in other words, when the data bit width adjustment value is equal to zero the data to be quantized corresponding to the current verify iteration has not changed at this time, and the updated second average value is equal to the second average value before the update. The second average value before the update is calculated according to the above formula (29). Optionally, if the data bit width adjustment value is equal to the preset parameter; in other words, when the data bit width adjustment value is equal to zero, the processor may not update the second average value; in other words, the processor may not perform the above step S117.

For example, the second average value M2=β×s^{t}+(1−β)×M1 before the update; when the target data bit width n2 of the current verify iteration equals initial data bit width ni addsΔn,where Δn represents the data bit width adjustment value. At this time, the updated second average value M2=β×(s^{t}−Δn)+(1−β)×(M1−Δn). When the target data bit width corresponding to the current verify iteration n2 equals the initial data bit width n1 minusΔn, where Δn represents the data bit width adjustment value. At this time, the updated second average value M2β×(s^{t}−Δn)+(1−β)×(M1+Δn), where s^{t} means that the point location of the current verify iteration is determined according to the target data bit width.

For another example, the second average value M2=β×s^{t}+(1−β)×M1 before the update; when the target data bit width n2 corresponding to the current verify iteration equals initial data hit width n1 addsΔn, where Δn represents the data hit width adjustment value. At this time, the updated second average value M2=β×s^{t}+(1−β)×M1−Δn. For another example, when the target data bit width n2 corresponding to the current verify iteration equals initial data bit width n1 minusΔn, where Δn represents the data bit width adjustment value. At this time, the updated second average value M2=β×s^{t}+(1−β)×M1+Δn, where s^{t} means that the point location of the current verify iteration is determined according to the target data bit width.

Further, as shown in FIG. 6, the above-mentioned S200 may include:

In the step S210, the first target iteration interval is determined according to the variation range of the point location, Where the first target iteration interval is negatively correlated to the above variation range of the point location. In other words, the greater the variation range of the above-mentioned point location, the smaller the first target iteration interval; the smaller the variation range of the above-mentioned point location, the greater the first target iteration interval.

As described above, the mentioned first error may represent the variation range of the point location. Therefore, as shown in FIG. 7, the above-mentioned step S210 may include the following steps:

In the step S211, the processor may determine the first target iteration interval according to the first error, where the first target iteration interval is negatively correlated with the first error. In other words, the larger the first error, the greater the variation range of the point location, and the greater the variation range of the data to be quantized, the smaller the first target iteration interval.

Specifically, the processor may obtain the first target iteration interval through calculation of the following formulaI:

$$\text{?} \qquad Formula ( 31 )$$

$$\text{?} \text{indicates text missing or illegible when filed}$$

In formula (31), I is the first target iteration interval, diff_{update1} represents the above-mentioned first error, andδ and γ may be hyperparameters.

It is understandable that the first error may be used to measure the variation range of the point location. The larger the first error, the greater the variation range of the point location, and the larger the data. variation range of the data. to be quantized, the smaller the first target iteration interval need to be set. In other words, the larger the first error, the more frequent the adjustment of the quantization parameters.

In this embodiment, the variation range (the first error) of the point location may be obtained through calculation, and the first target iteration interval is determined according to the variation range (the first error) of the point location. Since the quantization parameters are determined according to the first target iteration interval, the quantized data obtained according to the quantization parameters may be more in line with the variation trend of the point location of the target data, which may improve the computation efficiency of the recurrent neural network while ensuring the quantization precision.

Optionally, after determining the first target iteration interval at the current verify iteration, the processor may further determine parameters such as quantization parameters and data bit width corresponding to the first target iteration interval at the current verify iteration to update quantization parameters according to the first target iteration interval, where the quantization parameters may include the point location(s) and/or the scale factor. Further, the quantization parameters may also include the offset. The specific method of calculating the quantization parameters may refer to the above description. FIG. 14 is a flow chart. of a quantization parameter adjustment method in another embodiment of the present disclosure. As shown in FIG. 14, the above method may also include the following steps:

In the step S300, the processor may adjust the quantization parameters in the recurrent neural network computation according to the first target iteration interval.

Specifically, the processor may determine the update iterations (also called the verify iteration) according to the first target iteration interval and the total count of iterations in each cycle and update the first target iteration interval at each update iteration, and the quantization parameters at each update iteration. For example, the data bit width in the recurrent neural network computation may keep the same. At this time, the processor may directly adjust the quantization parameters such as the point location(s) according to the data to be quantized of the update iteration at each update iteration. For another example, the data. bit width in the recurrent neural network computation may be variable, At this time, the processor may update the data bit width at each update iteration and adjust the quantization parameters such as the point location(s) according to the updated data bit width and the data to he quantized in the update iteration.

In the embodiment of the present disclosure, the processor may update the quantization parameters at each verify iteration to ensure that the current quantization parameters meet the quantization requirement of the data to be quantized, where the first target iteration interval before and after the update may be the same or different. The data hit width before and after the update may be the same or different; in other words, the data bit width of different iteration intervals may be the same or different. The quantization parameters before and after the update may be the same or different; in other words, the quantization parameters of different iteration interval may be the same or different.

Optionally, in the above step S300, the processor may determine the quantization parameters in the first target iteration interval at the update iteration to adjust the quantization parameters in the recurrent neural network computation.

In a possible implementation, when the method is used in the training or fine-tuning process of the recurrent neural network, the step S200 may include the following steps:

The processor may determine whether the current verify iteration is greater than the first preset iteration, where when the current verify iteration is greater than the first preset iteration, the first target iteration interval is determined according to the data variation range of the data to be quantized, adjusting the quantization parameters according to a preset iteration interval when a current verify iteration is less than or equal to a first preset iteration.

The current verify iteration refers to the iterative computation currently performed by the processor. Optionally, the first preset iteration may be a hyperparatneter. The first preset iteration may be determined according to the data variation curve of the data to be quantized or may be may be customized by the user. Optionally, the first preset iteration may be less than the total count of iterations included in one epoch, where one epoch means that all data to be quantized in the data set complete one forward computation and one reverse computation.

Optionally, the processor may read the first preset iteration input by the user and determine the preset iteration interval according to the correspondence between the first preset iteration and the preset iteration interval. Optionally, the preset iteration interval may be a hyperparameter, and the preset iteration interval may be customized by the user. At this time, the processor may directly read the first preset iteration and the preset iteration interval input by the user and update the quantization parameters in the recurrent neural network computation according to the preset iteration interval. In the embodiment of the present disclosure, the processor may not need to determine the target iteration interval according to the data variation range of the data to be quantized.

For example, if the first preset iteration input by the user is the 100th iteration, and the preset iteration interval is 5, when the current verify iteration is less than or equal to the 100th iteration, the quantization parameters may be updated according to the preset iteration interval. In other words, the processor may determine to update the quantization parameters every 5 iterations from the first iteration to the 100th iteration of the training or fine-tuning of the recurrent neural network. Specifically, the processor may determine the quantization parameters such as the data bit width n1 and the point location s1 corresponding to the first iteration and use the data bit width n1 and the point location s1 to quantize the data to be quantized from the first iteration to the fifth iteration. In other words, the same quantization parameter may be used from the first iteration to the fifth iteration. After that, the processor may determine the quantization parameters such as the data bit width n.2 and the point location s2 corresponding to the 6th iteration and use the data bit width n2 and the point location s2 to quantize the data to be quantized from the 6th iteration to the 10th iteration. In other words, the same quantization parameter may be used from the 6th iteration to the 10th iteration. In the same way, the processor may follow the above-mentioned quantization method until the 100th iteration is completed, where the method for determining quantization parameters such as the data bit width and the point location(s) in each iteration interval may be referred to the above description, which will not be repeated here.

For another example, if the first preset iteration input by the user is the 100th iteration, and the preset iteration interval is 1, the quantization parameters may be updated according to the preset iteration interval when the current verify iteration is less than or equal to the 100th iteration. In other words, the processor may determine to update the quantization parameters from the first iteration to the 100th iteration of the training or fine-tuning of the recurrent neural network. Specifically, the processor may determine quantization parameters such as the data hit width n1 and the point location s1 corresponding to the first iteration, and use the data. bit width n1 and the point location s1 to quantize the data to be quantized in the first iteration After that, the processor may determine quantization parameters such as the data bit width n2 and the point location s2 corresponding to the second iteration and use the data bit width n2 and the point location s2 to quantize the data to be quantized in the second iteration. In the same way, the processor may determine quantization parameters such as the data hit width n100 and the point location s100 of the 100th iteration, and use the data bit width n100 and the point location s100 to quantize the data to he quantized in the 100th iteration. The method for determining quantization parameters such as the data bit width and the point location(s) in each iteration interval may be referred to the above description, which will not he repeated here.

The above is only an example in which the data. bit width and the quantization parameters are updated synchronously, aiming to explain that in other optional embodiments, the processor may also determine the iteration interval of the point location according to the variation range of the point location and update the quantization parameters such as the point location according to the iteration interval of the point location in each target iteration interval.

Optionally, when the current verify iteration is greater than the first preset iteration, it may indicate that the training or fine-tuning of the recurrent neural network is in the mid-stage. At this time, the data variation range of the data to be quantized in the historical iteration may be obtained, and the first target iteration interval may be determined according to the variation range of the data to be quantized. The first target iteration interval may be greater than the above-mentioned preset iteration interval, thereby reducing the number of updating the quantization parameters and improving the quantization efficiency and computation efficiency, Specifically, when the current verify iteration is greater than the first preset iteration, the first target iteration interval may be determined according to the variation range of the data to be quantized.

For another example, if the first preset iteration input by the user is the 100th iteration, and the preset iteration interval is 1, the quantization parameters may be updated according to the preset iteration interval when the current verify iteration is less than or equal to the 100th iteration. In other words, the processor may determine that the quantization parameters in each iteration are updated from the first iteration to the 100th iteration of the training or fine-tuning of the recurrent neural network, and the specific implementation manner may be referred to the above description. When the current verify iteration is greater than the 100th iteration, the processor may determine the variation range of the data to be quantized according to the data to be quantized in the current verify iteration and the data to be quantized in the previous historical iterations and determine the first target iteration interval based on the variation range of data to be quantized. Specifically, when the current verify iteration is greater than the 100th iteration, the processor may adaptively adjust the data bit width corresponding to the current verify iteration to obtain the target data bit width corresponding to the current verify iteration and make the target data bit width corresponding to the current verify iteration as the data bit width of the first target iteration interval. The data bit widths corresponding to iterations in the first target iteration interval are consistent, At the same time, the processor may determine the point location corresponding to the current verify iteration according to the target data bit width and the data to be quantized corresponding to the current verify iteration and determine the first error according to the point location corresponding to the current verify iteration. The processor may also determine the quantization error according to the data to be quantized corresponding to the current verify iteration and determine the second error according to the quantization error. Thereafter, the processor may determine the first target iteration interval according to the first error and the second error. The first target iteration interval may be greater than the above preset iteration interval. Further, the processor may determine the quantization parameters such as the point location of the scale factor in the first target iteration interval, and the specific determination method may refer to the above description.

For example, if the current verify iteration is the 100th iteration, the processor may determine that the iteration interval of the first target iteration interval is 3 according to the variation range of the data to be quantized, and the processor may determine that the first target iteration interval includes 3 iterations, which are respectively the 100th iteration, the 101st iteration, and the 102nd iteration. The processor may also determine the quantization error according to the data to be quantized in the 100th iteration, and determine the second error and the target data bit width corresponding to the 100th iteration according, to the quantization error, and use the target data bit width as the data bit width corresponding to the first target iteration interval. The data bit widths of the 100th iteration, the 101th iteration, and the 102th iteration are all the target data bit width corresponding to the 100th iteration. The processor may also determine the quantization parameters such as the point location and the scale factor corresponding to the 100th iteration according to the data to be quantized in the 100th iteration and the target data bit width corresponding to the 100th iteration. After that, the quantization parameters corresponding to the 100th iteration is used to quantize the 100th iteration, the 101st iteration, and the 102nd iteration,

In a possible implementation manner, the step S200 may also include:

determining the second target iteration interval corresponding to the current verify iteration according to the first target iteration interval and the total count of iterations in each cycle when the current verify iteration is greater than or equal to the second preset iteration, and the current verify iteration requires adjustment in quantization parameters;

determining an update iteration corresponding to the current verify iteration according to the second target iteration interval to adjust the quantization parameters in the update iteration, which is an iteration after the current verify iteration,

where the second preset iteration is greater than the first preset iteration, and a quantization adjustment process of the recurrent neural network includes a plurality of cycles, where iterations are not consistent in the plurality of cycles in terms of total count.

When the current verify iteration is greater than the first preset iteration, the processor may further determine whether the current verify iteration is greater than the second preset iteration, where the second preset iteration is greater than the first preset iteration, and the second preset iteration interval is greater than the preset iteration interval. Optionally, the above-mentioned second preset iteration may be a hyperparameter, and the second preset iteration may he greater than the total count of iterations in at least one cycle. Optionally, the second preset iteration may be determined according to the data variation curve of the data to be quantized. Optionally, the second preset interval may be customized by the user.

In a possible implementation manner, determining the second target iteration interval corresponding to the current verify iteration according to the first target iteration interval and the total count of iterations in each cycle includes:

determining an update cycle of the current verify iteration according to an iterative ordering number of the current verify iteration in a current cycle and the total count of iterations in a cycle after the current cycle, where the total count of iterations in the update cycle is greater than or equal to an iterative ordering number of the current verify iteration; and

determining the second target iteration interval according to the first target iteration interval, the iterative ordering number and the total count of iterations in the cycle between the current cycle and the update cycle.

For example, as shown in FIG. 5C, assume that I equals 1 in the first target iteration cycle. determining quantization parameters that need to be updated in the t₁ iteration of the first cycleiter₁, and then the next update iteration corresponding to the t₂ iteration of the first cycleiter₁ may be the t,₁ iteration in the second cycle iter₂. Determining quantization parameters that need to be updated in the t₂ iteration of the first cycle iter₁. Since the iterative number 3 of t₂ iteration of the first cycleiter₁ is greater than the total number of iterations of the second cycle, the next update iteration corresponding to the t₂ iteration of the first cycle iter₁ may become the t₂ iteration in the third cycle iter₃. Determining quantization parameters that need to be updated in the t₃ iteration of the first cycle iter₁. Since the iterative number 4 of the t₂ iteration of the first cycle iter₁ is greater than the total number of iterations of the second and third cycles, the next update iteration corresponding to the t₃ iteration of the first cycle iter₁ may become the t₃ iteration in the fourth cycle iter₄.

In this way, the processor may update the quantization parameters and the first target iteration interval according to the preset iteration interval and the second target iteration interval. For ease of description, the preset iteration interval and the second target iteration interval that are actually used for quantizing parameters and updating the first target iteration interval are referred to as the reference iteration interval or the target iteration interval.

In one case, data bit widths corresponding to each iteration in the recurrent neural network computation do not change, that is, data bit widths corresponding to each iteration in the recurrent neural network computation are the same. At this time, the processor may achieve the purpose of adjusting the quantization parameter in the recurrent neural network computation according to the reference iteration interval by determining quantization parameters such as the point location(s) in the reference iteration interval, where quantization parameters corresponding to the iterations in the reference iteration interval may be consistent. That is to say, each iteration in the reference iteration interval uses the same point location, and only update and determine quantization parameters such as the point location in each verify iteration to avoid updating and adjusting quantization parameters in each iteration, thereby reducing the amount of calculation in the quantization process and improving the quantization efficiency.

Optionally, for the above-mentioned case that the data bit width is unchanged, point location(s) corresponding to iterations in the reference iteration interval may be kept consistent. Specifically, the processor may determine the point location corresponding to the current verify iteration according to the data to be quantized in the current verify iteration and the target data bit width corresponding to the current verify iteration and use the point location corresponding to the current verify iteration as the point location corresponding to the reference iteration interval. Iterations in the reference iteration interval all follow the point location corresponding to the current verify iteration. Optionally, the target data bit width corresponding to the current verify iteration may be a hyperparameter. For example, the target data bit width corresponding to the current verify iteration is customized by the user. The point location corresponding to the current verify iteration may be calculated by referring to formula (2) or formula (14) above.

In one case, data bit widths corresponding to each iteration in the recurrent neural network computation may change; in other words, data bit widths corresponding to different reference iteration intervals may he inconsistent, but data bit widths of each iteration in the reference iteration interval are consistent. The data bit width corresponding to the iteration in the reference iteration interval may be a hyperparameter. For example, the data bit width corresponding to the iteration in the reference iteration interval may be customized by the user. In one case, the data bit width corresponding to the iteration in the reference iteration interval may also be obtained through calculation by the processor. For example, the processor may determine the target data bit width corresponding to the current verify iteration according to the data to be quantized in the current verify iteration and use the target data bit width corresponding to the current verify iteration as the data bit width corresponding to the reference iteration interval.

At this time, in order to simplify the calculation amount in the quantization process, quantization parameters such as the corresponding point location in the reference iteration interval may also keep the same. in other words, each iteration in the reference iteration interval uses the same point location, and only update and determine the data bit width and quantization parameters such as the point location to avoid updating and adjusting quantization parameters in each iteration, thereby reducing the amount of calculation in the quantization process and improving the efficiency of the quantization.

Optionally, for the above-mentioned case that the data bit width corresponding to the reference iteration interval is unchanged, point location(s) corresponding to iterations in the reference iteration interval may be kept consistent. Specifically, the processor may determine the point location corresponding to the current verify iteration according to the data to be quantized in the current verify iteration and the target data bit width corresponding to the current verify iteration and use the point location corresponding to the current verify iteration as the point location corresponding to the reference iteration interval. Iterations in the reference iteration interval all follow the point location corresponding to the current verify iteration. Optionally, the target data bit width corresponding to the current verify iteration may be a hyperparameter. For example, the target data bit width corresponding to the current verify iteration is customized by the user. The point location corresponding to the current verify iteration may be calculated by referring to formula (2) or formula (14) above.

Optionally, the scale factor corresponding to the iteration in the reference iteration interval may be consistent. The processor may determine the scale factor corresponding to the current verify iteration according to the data to be quantized in the current verify iteration, and use the scale factor corresponding to the current verify teration as the scale factor of each iteration in the reference iteration interval, where scale factors corresponding to iterations in the reference iteration interval are consistent.

Optionally, the offset corresponding to the iteration in the reference iteration interval may be consistent. The processor may determine the offset corresponding to the current verify iteration according to the data to be quantized of the current verify iteration, and use the offset corresponding to the current verify iteration as the offset of each iteration in the reference iteration interval. Further, the processor may also determine the minimum and the maximum value among all the elements of the data to be quantized, and further determine quantization parameters such as the point locations and the scale factors. Details may be provided with reference to the above description. The offset corresponding to iterations in the reference iteration interval may be consistent.

For example, the reference iteration interval may compute the number of iterations from the current verify iteration. In other words, the verify iteration corresponding to the reference iteration interval may be the initial iteration of the reference iteration interval. For example, if the current verify iteration is the 100th iteration, the processor may determine that the iteration interval of the reference iteration interval is 3 according to the data variation range of the data to be quantized, and the processor may determine that the reference iteration interval includes 3 iterations, which are respectively the 100th iteration, the 101st iteration, and a 102nd iteration. Furthermore, the processor may determine quantization parameters such as the point location corresponding to the 100th iteration according to the data to be quantized and the target data bit width corresponding to the 100th iteration and may use quantization parameters such as the point location corresponding to the 100th iteration to quantize the 100th iteration, the 101st iteration and the 102nd iteration. In this way, the processor does not need to calculate quantization parameters such as point locations in the 101st iteration and the 102nd iteration, which reduces the amount of calculation in the quantization process and improves the efficiency of the quantization operation.

Optionally, the reference iteration interval may also compute the number of iterations from the next iteration of the current verify iteration; in other words, the verify iteration corresponding to the reference iteration interval may also be the termination iteration of the reference iteration interval. For example, if the current verify iteration is the 100th iteration, the processor may determine that the iteration interval of the reference iteration interval is 3 according to the data variation range of the data to be quantized. Then the processor may determine that the reference iteration interval includes 3 iterations, which are respectively the 101st iteration, the 102nd iteration, and the 103rd iteration. Furthermore, the processor may determine quantization parameters such as the point location corresponding to the 100th iteration according to the data to be quantized and the target data bit width corresponding to the 100th iteration and may use quantization parameters such as the point location corresponding to the 100th iteration to quantize the 101st, the 102nd, and the 103rd iterations. In this way, the processor does not need to calculate quantization parameters such as the point location in the 102nd iteration and the 103rd iteration, which reduces the amount of calculation in the quantization process and improves the efficiency of the quantization operation.

In the embodiments of the present disclosure, data bit widths and quantization parameters corresponding to each iteration in the same reference iteration interval are all consistent in other words is, data hit widths, point location(s), scale factors, and offsets corresponding to each iteration in the same reference iteration interval are all the same, so that during the training or fine-tuning process of the recurrent neural network, frequent adjustment of the quantization parameters of the data to be quantized may be avoided, reducing the calculation amount in the quantization process may improve the quantization efficiency. In addition, the quantization accuracy may be ensured by dynamically adjusting the quantization parameters according to the data variation range at different stages of training or fine-tuning.

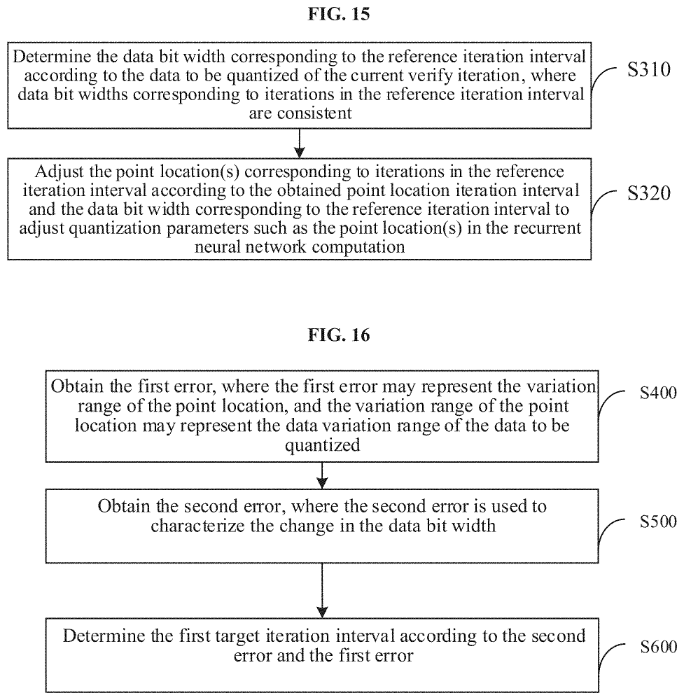

In another case, the data bit width corresponding to each iteration in the recurrent neural network computation may change, hut the data hit width of each iteration in the reference iteration interval may keep the same. At this time, quantization parameters such as the point location(s) corresponding to the iteration in the reference iteration interval may also be inconsistent. The processor may also determine the data bit width corresponding to the reference iteration interval according to the target data bit width corresponding to the current verify iteration, where data bit widths corresponding to the iteration in the reference iteration interval are consistent. After that, the processor may adjust quantitative parameters such as the point location(s) during the recurrent neural network computation according to the data bit width and the point location iteration interval corresponding to the reference iteration interval. Optionally, FIG. 15 shows a flowchart of adjusting quantization parameters in a quantization parameter adjustment method of an embodiment of the present disclosure. As shown in FIG. 15, the foregoing computation S300 may further include the following steps:

In the step S310, the data hit width is determined corresponding to the reference iteration interval according to the data to be quantized of the current verify iteration, where data bit widths corresponding to iterations in the reference iteration interval are consistent. In other words, the data bit width during the recurrent neural network is updated every other reference iteration interval. Optionally, the data bit width corresponding to the reference iteration interval may he the target data bit width of the current verify iteration. The description of the target data hit width of the current verify iteration may be seen in steps S114 and S115, which will not he repeated here.

For example, the reference iteration interval may compute the number of iterations from the current verify iteration. In other words, the verify iteration corresponding to the reference iteration interval may be the initial iteration of the reference iteration interval. For example, if the current verify iteration is the 100th iteration, the processor may determine that the reference iteration interval is 6 according to the data variation range of the data to be quantized, and then the processor may determine that the reference iteration interval includes 6 iterations, which are iterations from the 100th to the 105th. At this point, the processor may determine the target data bit width of the 100th iteration, and the target data bit width of the 100th iteration is used from the 101st iteration to the 105th iteration, which means target data bit widths from the 101st iteration to the 105th iteration do not need to be calculated, thereby reducing the amount of calculation, and improving the quantization efficiency and computation efficiency. After that, the 106th iteration may be used as the current verify iteration, and the above operations of determining the reference iteration interval and updating the data bit width are repeated.

Optionally, the reference iteration interval may also compute the number of iterations from the next iteration of the current verify iteration; in other words, the verify iteration corresponding to the reference iteration interval max also be the termination iteration of the reference iteration interval. For example, if the current verify iteration is the 100th iteration, the processor may determine that the iteration interval of the reference iteration interval is 6 according to the data variation range of the data to be quantized. Then the processor may determine that the reference iteration interval includes 6 iterations, which are iterations from the 101st iteration to the 106th respectively. At this time, the processor may determine the target data bit width of the 100th iteration, and the target data bit width of the 100th iteration is used from the 101st to 106th iterations, which means target data bit widths from the 101st iteration to the 106th iteration do not need to be calculated, thereby reducing the amount of calculation, and improving the quantization efficiency and computation efficiency. After that, the 106th iteration may be used as the current verify iteration, and the above operations of determining the reference iteration interval and updating the data bit width are repeated.

In the step S320, the processor may adjust the point location(s) corresponding to iterations in the reference iteration interval according to the obtained point location iteration interval and the data bit width corresponding to the reference iteration interval to adjust quantization parameters such as the point locationts in the recurrent neural network computation,

where the point location iteration interval includes at least one iteration, and point locations of iterations in the point location iteration interval are consistent. Optionally, the point location iteration interval may be a hyperparameter. For example, the point location iteration interval may also be customized by the user.

Optionally, the point location iteration interval is less than or equal to the reference iteration interval. When the point location iteration interval is the same as the mentioned reference iteration interval, the processor may synchronously update quantization parameters such as the data bit width and the point location(s) at the current verify iteration. Further optionally, the scale factor corresponding to the iteration in the reference iteration interval may be consistent. Furthermore, the offset corresponding to the iteration in the reference iteration interval may be consistent. At this time, quantization parameters such as the data bit width and the point location.(s) corresponding to the iteration in the reference iteration interval are all the same, thereby reducing the amount of calculation, and improving the quantization efficiency and the computation efficiency. The specific implement process is basically the same as the above embodiment, and may refer to the above description, which will not be repeated here.

When the point location iteration interval is less than the above-mentioned reference iteration interval, the processor may update quantization parameters such as the data bit width and the point location(s) at the verify iteration corresponding to the reference iteration interval, and update quantization parameters such as the point location(s) at the sub-verify iteration determined by the point location iteration interval. Since quantization parameters such as the point locations) may be fine-tuned according to the data to be quantized when the data bit width is unchanged. therefore quantization parameters such as the point location(s) may also he adjusted within the same reference iteration interval to further improve the quantization precision.

Specifically, the processor may determine the sub-verify iteration according to the current verify iteration and the point location iteration interval. The sub-verify iteration is used to adjust the point location(s), and the sub-verify iteration may be an iteration in the reference iteration interval. Further, the processor may adjust the point location(s) corresponding to the iteration in the reference iteration interval according to the data to be quantized in the sub-verify iteration and the data bit width corresponding to the reference iteration interval, where the point location determination method may refer to the above formula (2) or formula (14), which will not he repeated here.

For example, when the current verify iteration is the 100th iteration, the reference iteration interval is 6, and the reference iteration interval includes iterations from the 100th to the 105th. The point location iteration interval Iₛ₁ obtained by the processor is 3, and the point location(s) may be adjusted once every three iterations from the current verify iteration. Specifically, the processor may use the 100th iteration as the above-mentioned sub-verify iteration, calculate the point location s1 corresponding to the 100th iteration, and use the same point location s1 to quantize the 100th iteration, the 101st iteration, and the 102nd iteration. After that, the processor may use the 103rd iteration as the above sub-verify iteration according to the point location iteration intervalIₛ₁, and the processor may also determine the point location s2 corresponding to the second point location interval according to the data to be quantized corresponding to the 103rd iteration and the data bit width n corresponding to the reference iteration interval, and use the same point location s2 to quantize iterations from the 103rd to the 105th. In the embodiment of the present disclosure, the values of the point location s1 before update and the point location s2 after update may be the same or different. Further, the processor may re-determine the next reference iteration interval and quantization parameters such as the data. bit width and the point location(s) corresponding to the next reference iteration interval according to the data variation range of the data to be quantized in the 106th iteration,

For another example, when the current verify iteration is the 100th iteration, the reference iteration interval is 6. The reference iteration interval includes iterations from the 101st iteration to the 106th iteration. The point location iteration interval Iₛ₁ obtained by the processor is 3, and the point location(s) may be adjusted once every three iterations from the current verify iteration. Specifically, the processor may determine the point location s1 corresponding to the first point location iteration interval according to the data. to be quantized in the current verify iteration and the target data bit width n1 corresponding to the current verify iteration and use the point location s1 to quantize the 101st iteration, 102nd iteration and the 103rd iteration. After that, the processor may use the 104th iteration as the above sub-verify iteration according to the point location iteration interval At the same time, the processor may also determine the point location s2 corresponding to the second point location iteration interval according to the data to be quantized corresponding to the 104th iteration and the data bit width n1 corresponding to the reference iteration interval. The point location s2 may be used to quantize iterations from the 104th iteration to the 106th iteration. In the embodiment of the present disclosure, the values of the point location s1 before update and the point location s2 after update may be the same or different. Further, the processor may re-determine the next reference iteration interval and quantization parameters such as the data bit width and the point location(s) corresponding to the next reference iteration interval according to the data variation range of the data to be quantized in 106 iterations.

Optionally, the point location iteration interval may be equal to 1; in other words the point location is updated once for each iteration. Optionally, the point location iteration interval may be the same or different. For example, at least one point location iteration interval included in the reference iteration interval may increase sequentially. Examples are used here to illustrate the implementation manner of this embodiment, and it is not used to limit the present disclosure.

Optionally, the scale factor corresponding to iterations in the reference iteration interval may also be inconsistent. Further optionally, the scale factor may be updated synchronously with the above-mentioned point location(s); in other words, the iteration interval corresponding to the scale factor may be equal to the above point location iteration interval. In other words, whenever the processor updates the location of the determined point, the determined scale factor may be updated accordingly.

Optionally, the offset corresponding to the iteration in the reference iteration interval may also be inconsistent. Further, the offset may be updated synchronously with the above-mentioned point location; in other words, the iteration interval corresponding to the offset may be equal to the above-mentioned point location iteration interval. In other words, whenever the processor updates the location of the determined point, the determined offset may be updated accordingly. Of course, the offset may also be updated asynchronously with the above point location(s) or data bit width, which is not specifically limited here. Furthermore, the processor may also determine the minimum and maximum values among all the elements of the data to be quantized, and further determine quantization parameters such as point location(s) and scale factors. Details may refer to the above description.

In another embodiment, the processor may comprehensively determine the data variation range of the data to be quantized according to the variation range of the point location and the data bit width of the data to be quantized, and determine the reference iteration interval according to the data variation range of the data to be quantized, where the reference iteration interval may be used to update and determine the data bit width. In other words, the processor may update and determine the data bit width at each verify iteration of the reference iteration interval. Since the point location(s) may reflect the precision of the fixed-point data, and the data bit width may reflect the data representation range of the fixed-point data, the quantized data may be ensured not only to meet requirements of accuracy, but also may satisfy the data representation range by integrating the variation range of the point location and the data bit width variation of the data to be quantized. Optionally, the variation range of the point location may be characterized by the first error, and the change of the data bit width may be determined according to the above quantization error. Specifically, FIG. 16 shows a flowchart of a method for determining a first target iteration interval in a parameter adjustment method of another embodiment of the present disclosure. As shown in FIG. 16, the above method may include the following steps:

In the step S400, a first error is obtained. The first error may represent the variation range of the point location, and the variation range of the point location may represent the data variation range of the data to be quantized. The calculation method for the first error may refer to the step S100.

In the step S500, a second error is obtained. The second error is used to characterize the change in the data bit width.

Optionally, the above-mentioned. second error may be determined according to the quantization error, and the second error is positively correlated with the above-mentioned quantization error. In a possible implementation manner, the step S500 may include:

determining the quantization error according to the data to be quantized in the current verify iteration and the quantized data of the current verify iteration;

determining the second error according to the quantization error, where the second error is positively correlated with the quantization error,

and the quantized data of the current verify iteration is obtained by quantizing the data to be quantized of the current verify iteration according to the initial data bit width, and the specific quantization error determination method may be found in the step S114 and is not repeated here.

Specifically, the second error may he calculated according to the following formula:

diff_{update2}=θ*diff_{bit}² Formula (34).

In the formula (34), diff_{update2} represents the above-mentioned second error, and diff_{bit} represents the above-mentioned quantization error, and θ may he a hyperparameter

In the step S600, the first target iteration interval is determined according to the second error and the first error.

Specifically, the processor may calculate the target error according to the first error and the second error and determine the target iteration interval according to the target error. Optionally, the target error may be obtained by performing a weighted average calculation on the first error and the second error. For example, the target error is equal to K*first error plus (1−K) *second. error, where K is a hyperpara.meter. After that, the processor may determine the target iteration interval according to the target error, where the target iteration interval is negatively correlated. with the target error. In other words, the larger the target error, the smaller the target iteration interval.

Optionally, the target error may also he determined according to the maximum and minimum value of the first error and the second error, and at this time, the weight of the first error or the second error takes the value of 0. In a possible implementation manner, the step S600 max include:

taking a maximum value between the first error and the second error as a target error; and

determining the first target iteration interval according to the target error, where the target error is negatively correlated with the first target iteration interval;

Specifically, the processor may compare the magnitude of the first error diff_{update1} and the second error diff_{update2}, and when the first error diff_{update1} is greater than the second error diff_{update2}, the target error is equal to the first error diff_{update1} . When the first error diff_{update1} is less than the second error, the target error is equal to the second error diff_{update2}. When the first error diff_{update1} is equal to the second error, the target error may be the first error diff_{update1} or the second error diff_{update2} . That is, the target error diff_{update} may be determined according to the following formula:

diff_{update}=max (diff_{update1}, diff_{update2}) Formula (35).

Among them, diff_{update} refers to the target error, diff_{update1} refers to the first error, and diff_{update1} refers to the second error.

Specifically, the first target iteration interval may be determined as follows:

The first target iteration interval may be calculated according to the following formula:

$$I = \frac{β}{{diff}_{update}} - γ . \qquad Formula ( 36 )$$

Among them, I represents the target iteration interval, diff_{update} represents the above-mentioned target error,δandγmay be the hyperparameter.

Optionally, in the above embodiment, the data bit width of the recurrent neural network computation is variable, and the variation trend of the data bit width may be measured by the second error. In this case, after determining the first target iteration interval, the processor may determine the second target iteration interval and the data bit width corresponding to the iteration in the second target iteration interval, where the data bit width corresponding to iterations in the second target iteration interval are consistent. Specifically, the processor may determine the data bit width corresponding to the second target iteration interval according to the data to be quantized of the current verify iteration. In other words, the data bit width during the recurrent neural network computation is updated every second target iteration interval. Optionally, the data bit width corresponding to the second target iteration interval may be the target data bit width of the current verify iteration. The description of the target data bit width of the current verify iteration may be seen in steps S114 and S115, which will not be repeated here.

For example, the second target iteration interval may calculate the number of iterations from the current verify iteration; in other words the verify iteration corresponding to the second target iteration interval may be the initial iteration of the second target iteration interval. For example, if the current verify iteration is the 100th iteration, the processor may determine that the iteration interval of the second target iteration interval is 6 according to the data variation range of the data to be quantized, and the processor may determine that the second target iteration interval includes 6 iterations, which are respectively iterations from the 100th iteration to the 105th iteration. At this point, the processor may determine the target data bit width of the 100th iteration, and the target data bit width of the 100th iteration is used from the 101st iteration to the 105th iteration, which means target data bit widths from the 101st iteration to the 105th iteration do not need to be calculated, thereby reducing the amount of calculation, and improving the quantization efficiency and computation efficiency. After that, the 106th iteration may be used as the current verily iteration, and the above operations of determining the second target iteration interval and updating the data bit width may be repeated.

Optionally, the second target iteration interval may also be calculated from the next iteration of the current verify iteration; in other words, the verify iteration corresponding to the second target iteration interval may also be the termination iteration of the second target iteration interval. For example, if the current verify iteration is the 100th iteration, the processor may determine that the iteration interval of the second target iteration interval is 6 according to the data variation range of the data to be quantized. Then the processor may determine that the second target iteration interval includes 6 iterations, which are respectively iterations from the 101st iteration to the 106th iteration. At this time, the processor may determine the target data bit width of the 100th iteration, and the target data bit width of the 100th iteration is used from the 101st to 106th iterations, which means target data bit widths from the 101st iteration to the 106th iteration do not need to be calculated, thereby reducing the amount of calculation, and improving the quantization efficiency and computation efficiency. After that, the 106th iteration may be used as the current verify iteration, and the above operations of determining the target iteration interval and updating the data bit width may be repeated.

Still further, the processor may also determine the quantization parameters in the second target iteration interval at the verify iteration and adjust the quantization parameters in the recurrent neural network computation according to the second target iteration interval. In other words, quantization parameters such as the point location(s) in the recurrent neural network computation may be updated synchronously with the data bit width.

In one case, the quantization parameters corresponding to the iteration in the second target iteration interval may be consistent. Optionally, the processor may determine the point location corresponding to the current verify iteration according to the data to be quantized in the current verify iteration and the target data bit width corresponding to the current verify iteration, and use the point location corresponding to the current verify iteration as the point location corresponding to the second target iteration interval, where point location(s) corresponding to iterations in the second target iteration interval are consistent. In other words, each iteration in the second target iteration interval uses quantization parameters such as the point location of the current verify iteration, which avoids updating and adjusting quantization parameters in each iteration, thereby reducing the amount of calculation in the quantization process and improving the efficiency of the quantization.

Optionally, the scale factor corresponding to the iteration in the second target iteration interval may be consistent. The processor may determine the scale factor corresponding to the current verify iteration according to the data to be quantized of the current verify iteration, and use the scale factor corresponding to the current verify iteration as the scale factor of each iteration in the second target iteration interval, where the scale factor corresponding to the iteration in the second target iteration interval is consistent.

Optionally, the offset corresponding to the iteration in the second target iteration interval may be consistent. The processor may determine the offset corresponding to the current verify iteration according to the data to be quantized of the current verify iteration, and use the offset corresponding to the current verify iteration as the offset of each iteration in the second target iteration interval. Further, the processor may also determine the minimum and the maximum value among all the elements of the data to be quantized, and further determine quantization parameters such as the point locations and the scale factors. Details may be provided with reference to the above description. The offset corresponding to the iteration in the second target iteration interval may be consistent.

For example, the second target iteration interval may calculate the number of iterations from the current verify iteration; in other words the verify iteration corresponding to the second target iteration interval may be the initial iteration of the second target iteration interval. For example, if the current verify iteration is the 100th iteration, the processor may determine that the iteration interval of the second target iteration interval is 3 according to the data variation range of the data to be quantized, and the processor may determine that the second target iteration interval includes 3 iterations, which are the 100th iteration, the 101st iteration and the 102nd iteration respectively. Furthermore, the processor may determine quantization parameters such as the point location corresponding to the 100th iteration according to the data to be quantized and the target data bit width corresponding to the 100th iteration and may use quantization parameters such as the point location corresponding to the 100th iteration to quantize the 100th iteration, the 101st iteration and the 102nd iteration. In this way, the processor does not need to calculate quantization parameters such as point locations in the 101st iteration and the 102nd iteration, which reduces the amount of calculation in the quantization process and improves the efficiency of the quantization.

Optionally, the second target iteration interval may also be calculated from the next iteration of the current verify iteration; in other words, the verify iteration corresponding to the second target iteration interval may also be the termination iteration of the second target iteration interval. For example, if the current verify iteration is the 100th iteration, the processor may determine that the iteration interval of the second target iteration interval is 3 according to the data variation range of the data to be quantized. Then the processor may determine that the second target iteration interval includes 3 iterations, which are respectively the 101st iteration, the 102nd iteration and the 103rd. Furthermore, the processor may determine quantization parameters such as the point location corresponding to the 100th iteration according to the data to he quantized and the target data bit width corresponding to the 100th iteration and may use quantization parameters such as the point location corresponding to the 100th iteration to quantize the 101st, the 102nd, and the 103rd iterations. In this way, the processor does not need to calculate quantization parameters such as the point location in the 102nd iteration and the 103rd iteration, which reduces the amount of calculation in the quantization process and improves the efficiency of the quantization.

In the embodiments of the present disclosure, the data bit widths and quantization parameters corresponding to each iteration in the same second target iteration interval are the same; in other words data bit widths, point location(s), scale factors, and offsets corresponding to each iteration in the same second target iteration interval may keep the same, so that during the training or fine-tuning process of the recurrent neural network, frequent adjustment of quantization parameters of the data to be quantized may he avoided, thereby reducing the calculation amount in the quantization process, and improving the quantization efficiency. In addition, the quantization accuracy may be ensured by dynamically adjusting the quantization parameters according to the data variation range at different stages of training or fine-tuning.

In another case, the processor may also determine the quantization parameters in the second target iteration interval according to the point location iteration interval corresponding to quantization parameters such as the point location to adjust the quantization parameters in the recurrent neural network computation. In other words, quantization parameters such as the point location in the recurrent neural network computation may he updated asynchronously with the data bit width. The processor may update quantization parameters such as the data bit width and the point loca.tion(s) at the verify iteration of the second target iteration interval, and the processor may also update the point location(s) alone corresponding to the iteration in the second target iteration interval according to the point location iteration interval.

Specifically, the processor may also determine the data bit width corresponding to the second target iteration interval according to the target data hit width corresponding to the current verify' iteration, where the data bit widths corresponding to the iterations in the second target iteration interval are consistent. Then, the processor may adjust quantization parameters such as the point location(s) in the recurrent neural network computation according to the data bit width and the point location iteration interval corresponding to the second target iteration interval. After determining the data hit width corresponding to the second target iteration interval, the processor adjusts the point location(s) corresponding to iterations in the second target iteration interval according to the obtained point location iteration interval and the data bit width corresponding to the second target iteration interval to adjust the point location(s) in the recurrent neural network computation. The point location iteration interval includes at least one iteration, and point locations of iterations in the point location iteration interval are consistent. Optionally, the preset iteration interval may be a hyperparameter. For example, the point location iteration interval may also be customized by the user.

In an optional embodiment, the above-mentioned method may be used in the training or fine-tuning process of the recurrent neural network to adjust the quantization parameters of the computation data involved in the training or fine-tuning process of the recurrent neural network to improve the quantification precision and efficiency of the computation data involved in the recurrent neural network computation. The computation data may be at least one of neuron data, weight data, or gradient data. As shown in FIG. 5A, according to the data variation curve of the data to be quantized, it may be seen that in the initial stage of training or fine-tuning, the difference between the data to be quantized in each iteration is relatively large, and the data variation range of the data to be quantized is relatively drastic. At this time, the value of the target iteration interval may be small, so that the quantization parameters in the target iteration interval may be updated timely to ensure the quantization precision. In the mid-stage of training or fine-tuning, the data variation range of the data to be quantized gradually flattens. At this time, the value of the target iteration interval may be increased to avoid frequent updating of quantization parameters to improve quantization efficiency and calculation efficiency. In the later stage, the training or fine-tuning of the recurrent neural network tends to be stable (in other words, when the positive computation result of the recurrent neural network approaches the preset reference value, the training or fine-tuning of the recurrent neural network tends to be stable). At this time, the value of the target iteration interval may be further increased to further improve the quantization efficiency and calculation efficiency. Based on the above-mentioned data variation trend, different methods may be used to determine the target iteration interval at different stages of the training or fine-tuning of the recurrent neural network to improve the quantization efficiency and calculation efficiency on the basis of ensuring the quantization precision

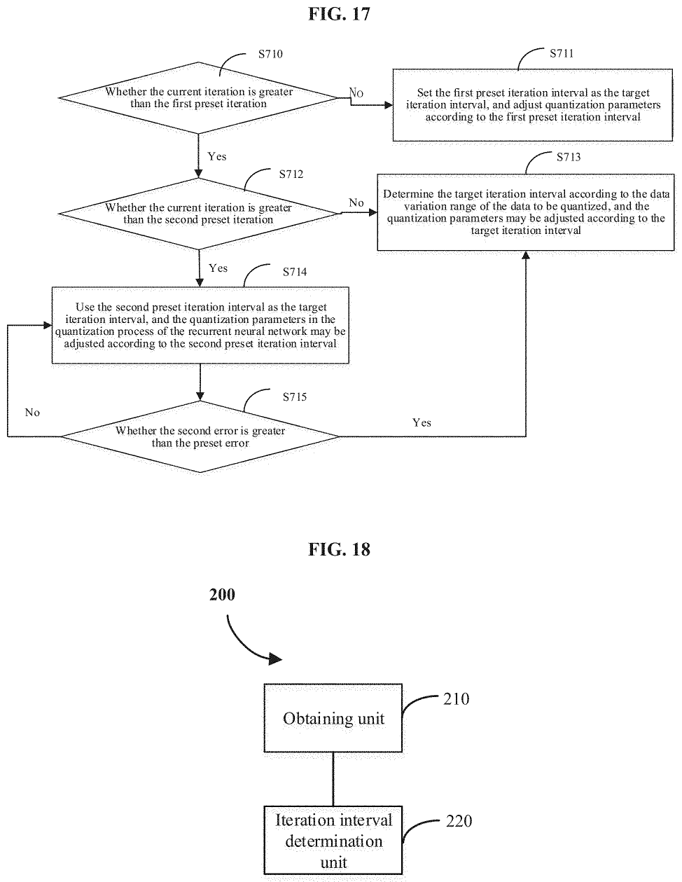

Further, FIG. 17 shows a flowchart of a quantization parameter adjustment method of another embodiment of the present disclosure. As shown in FIG. 17, the above method may further include the following steps:

When the current iteration is greater than the first preset iteration, the processor may further perform the step S712. In other words, the processor may further determine whether the current iteration is greater than the second preset iteration, where the second preset iteration is greater than the first preset iteration, and the second preset iteration interval is greater than the first preset iteration interval. Optionally, the above-mentioned second preset iteration may be a hyperparameter, and the second preset iteration may be greater than the total count of iterations in at least one cycle. Optionally, the second preset iteration may be determined according to the data variation curve of the data to be quantized. Optionally, the second preset interval may be customized by the user.

When the current verify is greater than or equal to the second preset iteration, the processor may perform the step S714, which means that the second preset iteration interval may he used as the target iteration interval and the quantization parameters in the quantization process of the recurrent neural network may be adjusted according to the second preset iteration interval. When the current iteration is greater than the first preset iteration, and the current iteration is less than the second preset iteration, the processor may perform the above-mentioned step S713, in other words, the target iteration interval may be determined according to the data variation range of the data to be quantized, and the quantization parameters may be adjusted according to the target iteration interval.

Optionally, the processor may read the second preset iteration set by the user and determine the second preset iteration interval according to the correspondence between the second preset iteration and the second preset iteration interval The second preset iteration is greater than the first preset iteration interval. Optionally, when the degree of convergence of the neural network meets the preset condition, it may be determined that the current iteration is greater than or equal to the second preset iteration. For example, when the forward computation result of the current iteration approaches the preset reference value, it may be determined that the degree of convergence of the neural network meets the preset condition. At this time, it may be determined that the current iteration is greater than or equal to the second preset iteration, or when the loss value corresponding to the current iteration is less than or equal to the preset threshold, it may be determined that the degree of convergence of the neural network meets the preset condition.

Optionally, the mentioned second preset iteration interval may be a. hyperparameter, and the second preset iteration interval may be greater than or equal to the total count of iterations of at least one training epoch. Optionally, the second preset iteration interval may be customized by the user. The processor may directly read the second preset iteration and the second preset iteration interval input by the user and update the quantization parameters in the neural network computation according to the second preset iteration interval. For example, the second preset iteration interval may he equal to the total count of iterations of one training cycle; in other words the quantization parameters are updated once every training epoch.

Furthermore, the above method may also include:

determining whether the current data bit width needs to he adjusted at each verify iteration by the processor when the current iteration is greater than or equal to the second preset iteration. If the current data bit width needs to be adjusted, the processor may switch from the above step S714 to S713 to re-determine the data bit width, so that the data bit width may meet requirements of the data to be quantized.

Specifically, the processor may determine whether the data bit width needs to be adjusted according to the above-mentioned second error. The processor may also perform the above step S715 to determine whether the second error is greater than the preset error. When the current iteration is greater than or equal to the second preset iteration and the second error is greater than the preset error, the processor may switch to perform the step S713. The iteration interval may be determined according to the data variation range of the data to be quantized to re-determine the data bit width according to the iteration interval. If the current iteration is greater than or equal to the second preset iteration, and the second error is less than or equal to the preset error value, the processor may continue to perform the step S714. The second preset iteration interval may be used as the target iteration interval and parameters in the quantization process of the neural network may be adjusted according to the second preset iteration interval, and the preset error value may be determined according to the preset threshold corresponding to the quantization error. When the second error is greater than the preset error value, the data bit width may need to be further adjusted. The processor may determine the iteration interval according to the data variation range of the data to be quantize to re-determine the data bit width according to the iteration interval.

For example, the second preset iteration interval is the total count of iterations in one training epoch. When the current iteration is greater than or equal to the second preset iteration, the processor may update the quantization parameters according to the second preset iteration interval; in other words the quantization parameters are updated once every training epoch. At this time, the initial iteration of each training epoch is regarded as the verify iteration. At the initial iteration of each training epoch, the processor may determine the quantization error according to the data to be quantized in the verify iteration, and determine the second error according to the quantization error, and determine whether the second error is greater than the preset error according to the following formula:

diff_{update2}=θ*diff_{bit}²>T.

Among them, diff_{update2} represents the second error, diff_{bit} represents the quantization error,θ represents the hyperparameter,Tand represents the preset error value. Optionally, the preset error may be equal to the value the first preset threshold divided by the hyperparameter. Of course, the preset error value may also be a hyperparameter. For example, the preset error value may be calculated according to the following formula: T=th/10, where th represents the first preset threshold, and the value of the hyperparameter is 10.

If the second error diff_{update2} is greater than the preset error value T, it means that the data bit width may not meet the preset requirements. In this case, the second preset iteration interval may no longer be used to update the quantization parameters, and the processor may follow the data change range of the data to be quantized Determine the target iteration interval to ensure that the data bit width meets the preset requirements. That is, when the second error diff_{update2} is greater than the preset error valueT, the processor switches from operation S714 to operation S713.

Of course, in other embodiments, the processor may determine whether the data bit width needs to be adjusted according to the above-mentioned quantization error. For example, the second preset iteration interval is the total count of iterations in one training epoch. When the current iteration is greater than or equal to the second preset iteration, the processor may update the quantization parameters according to the second preset iteration interval; in other words, the processor may update the quantization parameters once every training epoch. Among them, the initial iteration of each training cycle is used as the verify iteration.. At the initial iteration of each training epoch, the processor may determine the quantization error according to the data to be quantized in the test iteration, and if the quantization error is greater than or equal to the first preset threshold, the data bit width may not meet the preset requirements, and the processor may switch from the step S714 to S713.

In an optional embodiment, the above-mentioned quantization parameters such as the point location(s), the scale factor and the offset may be displayed on a display apparatus. At this time, the user may learn the quantization parameters daring the recurrent neural network computation through the display apparatus, and the user may also adaptively modify the quantization parameters determined by the processor. In the same way, the above-mentioned. data bit width and target iteration interval may also be displayed by the display apparatus. At this time, the user may obtain parameters such as the target iteration interval and data bit width during the recurrent neural network computation through the display apparatus, and the user may also adaptively modify parameters such as the target iteration interval and data bit width determined by the processor.

It should be noted that, the foregoing embodiments of method, for the sake of conciseness, are all described as a series of combinations of actions, but those skilled in the art should know that the present disclosure is not limited by the described order of action since the steps may be performed in a different order or simultaneously according to the present disclosure. Secondly, those skilled in the art should also understand that the embodiments described in the specification are all optional, and the actions and units involved are not necessarily required for this disclosure.

An embodiment of the present disclosure also provides a quantization parameter adjustment apparatus 200 of the recurrent neural network, and the quantization parameter adjustment apparatus 200 may be set in a processor. For example, the quantization parameter adjustment apparatus 200 may he placed in a general-purpose processor. For another example, the quantization parameter adjustment apparatus may also be placed in an artificial intelligence processor. FIG. 18 shows an obtaining unit 210 of the embodiment of the present disclosure.

The obtaining unit 210 is configured to obtain the variation range of the data to be quantized.

The iteration interval deterniining unit 220 is configured to determine the first target iteration interval according to the data variation range of the data to be quantized to adjust quantization parameters in the recurrent neural network computation according to the first target iteration interval. The target iteration interval includes at least one iteration, and the quantization parameters of the recurrent neural network is configured to implement quantization of the data to he quantized in the recurrent neural network computation.

In a possible implementation manner, the apparatus further includes:

a preset interval determining unit, which is configured to adjust the quantization parameters according to the preset iteration interval when a current verify iteration is less than or equal to a first preset iteration.

In a possible implementation manner, the iteration interval determining unit is further configured to determine the first target iteration interval according to the data variation range of the data to be quantized when the current verify iteration is greater than the first preset iteration.

In a possible implementation manner, the iteration interval determining unit includes:

a second target iteration interval determining sub-unit, which determines a second target iteration interval corresponding to the current verify iteration according to the first target iteration interval and the total count of iterations in each cycle when the current verify iteration is greater than or equal to a second preset iteration, and the current verify iteration requires a second adjustment in quantization parameters; and

an update iteration determining sub-unit, which determines an update iteration corresponding to the current verify iteration according to the second target iteration interval to adjust the quantization parameters of the update iteration, which is the iteration after the current verify iteration,

where the second preset iteration is greater than the first preset iteration, and a quantization adjustment process of the recurrent neural network includes a plurality of cycles, where iterations are not consistent in the plurality of cycles in terms of total count.

In a possible implementation manner, the second target iteration interval determining sub-unit may include:

an update cycle determining sub-unit, which determines an update cycle corresponding to the current verify iteration according to the iterative ordering number of the current verify iteration in the current cycle and the total count of iterations in cycles after the current cycle. where the total count of iterations in the update cycle is greater than or equal to the iterative number; and

a determining sub-unit, which determines the second target iteration interval according to the first target iteration interval, the iterative number, and the total count of iterations in the cycle between the current cycle and the update cycle.

In a possible implementation manner, the iteration interval determining unit is further configured to determine, whether the current verify iteration is greater than or equal to the second preset iteration when the degree of convergence of the recurrent neural network meets the preset condition.

In a possible implementation manner, quantization parameters include the point location(s), and the point location(s) is the location of a decimal point in the quantization data corresponding to the data to be quantized; the apparatus further includes:

a quantization parameter determining unit, which is configured to determine the point ocation(s) corresponding to an iteration in a reference iteration interval according to a target data bit width corresponding to the current verify iteration and the data to he quantized of the current verify iteration to adjust the point location(s) in the recurrent neural network computation; and

where the point location.(s) corresponding to iteration(s) in the reference iteration interval are consistent, and the reference iteration interval includes the second target iteration interval or the preset iteration interval.

In a possible implementation manner, quantization parameters include the point location(s), and the point location(s) is the location of a decimal point in the quantization data corresponding to the data to he quantized; the apparatus further includes:

a data bit width determining unit, which is configured to determine a data bit width corresponding to the reference iteration interval according to a target data bit width corresponding to the current verify iteration, where the data bit width corresponding to the iteration in the reference iteration interval is consistent, and the reference iteration interval includes the second target iteration interval or the preset iteration interval; and

a quantization parameter determining unit, which is configured to adjust the point location(s) corresponding to the iteration in the reference iteration interval according to the obtained point location iteration interval and the data bit width corresponding to the reference iteration interval to adjust the point location(s) in the neural network computation,

where the point location iteration interval includes at least one iteration, and point locations of iterations in the point location iteration interval are consistent.

In a possible implementation manner, the point location iteration interval is less than or equal to the reference iteration interval.

In a possible implementation manner, quantization parameters further include the scale factor, which is updated synchronously with the point location.

In a possible implementation manner, quantization parameters further include an offset, which is updated synchronously with the point location(s).

In a possible implementation manner, the data bit width determining unit may include:

a quantization error determining sub-unit, which is configured to determine a quantization error according to the data to be quantized and the quantized data of the current verify iteration, where the quantized data of the current verify iteration is obtained by quantizing the data to be quantized of the current verify iteration; and

a data bit width determining sub-unit, which is configured to determine the target data bit width corresponding to the current verify iteration according to the quantization error.

In a possible implementation manner, the data hit width determining unit is configured to determine the target data bit width corresponding to the current verify iteration according to the quantization error, and is specifically configured to:

increase the data bit width corresponding to the current verify iteration to obtain the target data bit width corresponding to the current verify iteration if the quantization error is greater than or equal to the first preset threshold; or

reduce the data bit width corresponding to the current verify iteration to obtain the target data bit width corresponding to the current verify iteration if the quantization error is less than or equal to the second preset threshold.

In a possible implementation manner, the data hit width determining unit is configured to increase the data hit width corresponding to the current verify iteration to obtain the data bit width corresponding to the current verify iteration if the quantization error is greater than or equal to the first preset threshold, is specifically configured to:

determine the first intermediate data bit width according to the first preset bit width stride if the quantization error is greater than or equal to the first intermediate data bit width

return to determine the quantization error according to the data to be quantized in the current verify iteration and the quantized data of the current verify iteration until the quantization error is less than the first preset threshold, where the quantized data of the current verify iteration is obtained by quantizing the data to he quantized of the current verify iteration according to the bit width of the first intermediate data.

In a possible implementation manner, the data bit width determination unit is configured to reduce the data bit width corresponding to the current verify iteration if the quantization error is less than or equal to the second preset threshold to obtain the target data. bit width corresponding to the current verify iteration, is specifically configured to:

determine the second intermediate data bit width according to the second preset bit width stride if the quantization error is less than or equal to the second preset threshold;

return to determine the quantization error according to the data to be quantized in the current verify iteration and the quantized data of the current verify iteration until the quantization error is greater than the second preset threshold, where the quantized data of the current verify iteration is obtained by quantizing the data to be quantized of the current verify iteration according to the bit width of the second intermediate data.

In a possible implementation manner, the obtaining unit includes:

a first obtaining unit which is configured to obtain the variation range of the point location, where the variation range of the point location is used to characterize the data variation range of the data to be quantized, and the variation range of the point location is positively correlated with the data variation range of the data to be quantized.

In a possible implementation manner, the first obtaining unit includes:

a first average value determining unit, which is configured to determine a first average value according to the point location corresponding to the previous verify iteration before the current verify iteration, and point location(s) of the historical iteration(s) before the previous verify iteration, where the previous verify iteration is the verify iteration corresponding to the previous iteration interval before the target iteration interval;

a second average value determining unit, which is configured to determine a second average value according to the point location corresponding to the current verify iteration and point location(s) of the historical verify iterations before the current verify iteration, where the point location corresponding to the current verify iteration is determined according to the target data bit width corresponding to the current verify iteration and the data to be quantized; and

the first error determination unit, which is configured to determine the first error according to the first average value and the second average value, and the first error is configured to characterize the variation range of the point location.

in a possible implementation manner, the second average value determination unit is specifically configured to:

obtain a preset number of intermediate moving average values, where each intermediate moving average value is determined according to the verify iteration of the preset number before the current verify iteration; and

determine the second average value according to the point location(s) of the current verify iteration and the preset number of intermediate moving average values.

In a possible implementation manner, the second average value determination unit is specifically configured to determine the second average value according to a point location corresponding to the current verify iteration and the first average value.

In a possible implementation manner, the second average value determining unit is configured to update the second average value according to the acquired data bit width adjustment value of the current verify iteration,

where the data bit width adjustment value of the current verify iteration is determined by the target data bit width and the initial data bit width of the current verify iteration.

In a possible implementation manner, the second average value determining unit is configured to update the second average value according to the acquired data bit width adjustment value of the current verify iteration, and is specifically configured to:

decrease the second average value according to the data bit width adjustment value of the current verify iteration when the data bit width adjustment value of the current verify iteration is greater than the preset parameter;

increase the second average value according to the data bit width adjustment value of the current verify iteration when the data bit width adjustment value of the current verify iteration is smaller than the preset parameter.

In a possible implementation manner, the iteration interval determination unit is configured to determine the target iteration interval according to the first error, and the target iteration interval is negatively correlated with the first error.

In a possible implementation manner, the obtaining unit further includes:

a second obtaining unit, which is configured to acquire the change trend of the data bit width and determine the data variation range of the data to be quantified according to the variation range of the point location and the variation trend of the data bit width.

In a possible implementation manner, the iteration interval determination unit is further configured to determine the target iteration interval according to the acquired first error and second error. The first error is used to characterize the variation range of the point location, and the second error is used to characterize the variation trend of the data. bit width.

In a possible implementation manner, the iteration interval determination unit is used to determine the target iteration interval according to the acquired first error and second error, is specifically configured to:

take the maximum value of the first error and the second error as a target error;

determine the target iteration interval according to the target error, where the target error is negatively correlated with the target iteration interval.

In a possible implementation manner, the second error is determined according to the quantization error,

where the quantization error is determined according to the data to be quantized and the quantized data of the current verify iteration, and the second error is positively correlated with the quantization error.

In a possible implementation manner, the iteration interval determination unit is further configured to determine the first target iteration interval according to the data variation range of the quantized data when the current verify iteration is greater than or equal to the second preset iteration, and the second error is greater than the preset error value.

It should be clear that working principles of each unit or unit of the embodiment of the present application is basically the same as the implementation process of each operation in the foregoing method, and details may refer to the above description. It should be understood that the foregoing apparatus embodiments are only illustrative, and the apparatus of the present disclosure may also be implemented in other ways. For example, the division of the units/modules in the foregoing embodiment is only a logical function division, and there may be other division methods in actual implementation. For example, a plurality of units, modules, or components may be combined or integrated into another system, or some features may be omitted or not implemented. The above-mentioned integrated units/modules may be implemented in the form of hardware or in the form of software program units. When the above-mentioned integrated units/modules are implemented in the form of hardware, the hardware may be a digital circuit, an analog circuit, and the like. Physical implementation of the hardware structure may include, but is not limited to, a. transistor, a memristor, and the like.

If the integrated units/modules are implemented in the form of software program units and sold or used as an independent product, the product may be stored in a computer-readable memory. Based on such understanding, the essence of the technical solutions of the present disclosure, or a part of the present disclosure that contributes to the prior art, or all or part of technical solutions, may all or partly embodied in the form of a software product that is stored in a memory. The software product includes several instructions to enable a computer apparatus (which may be a personal computer, a server, or a network apparatus, and the like) to perform all or part of the steps of the methods described in the examples of the present disclosure. The foregoing memory includes: a USB flash drive, a read-only memory (ROM), a random-access memory (RAM), a mobile hard disk, a magnetic disk, or an optical disc, and other media that may store program codes.

In an embodiment, the present disclosure also provides a computer-readable storage medium in which a computer program is stored, and when the computer program is executed by a processor or an apparatus, the method as in any of the above-mentioned embodiments is implemented. Specifically, when the computer program is executed by a processor or an apparatus, the following method is implemented:

obtaining a data variation range of data to be quantized; and

determining the target iteration interval according to the variation range of the data to be quantized to adjust quantization parameters in the recurrent neural network computation according to the target iteration. interval. The target iteration interval includes at least one iteration, and quantization parameters of the recurrent neural network are configured to implement quantization of the data to be quantized in the recurrent neural network computation.

It should be clear that the implementation of each operation in the embodiments of the present application is basically the same as the implementation process of each operation in the foregoing method. Details may refer to the above description.

In the embodiments above, descriptions of each embodiment have their own emphasis. For a part that is not described in detail in one embodiment, reference may be made to related descriptions in other embodiments. Each technical features of the embodiments above may be randomly combined, For conciseness, not all possible combinations of the technical features of the embodiments above are described. Yet, provided that there is no contradiction, combinations of these technical features fall within the scope of the description of the present specification.

In a possible implementation manner, an artificial intelligence chip is also disclosed, which includes the above-mentioned quantization parameter adjustment apparatus.

In a possible implementation manner, a board card is also disclosed, which includes a storage apparatus, an interface apparatus, a control apparatus, and the above artificial intelligence chip, where the artificial intelligence chip is connected to the storage apparatus, the control apparatus and the interface apparatus respectively; the storage apparatus is used to store data; the interface apparatus is used to realize data transmission between the artificial intelligence chip and the external apparatus; and the control apparatus is used to monitor a state of the artificial intelligence chip.

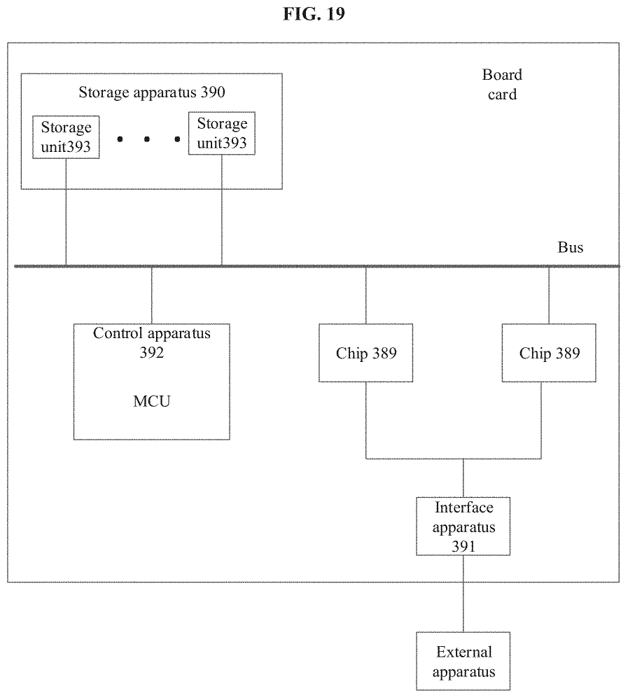

FIG. 19 shows a structural block diagram of a board card according to an embodiment of the present disclosure. Referring to FIG. 19, the above-mentioned board card may include other supporting components in addition to the chip 389, and supporting components include, but are not limited to: a storage apparatus 390, an interface apparatus 391 and a control apparatus 392;

the storage component 390 is connected to the artificial intelligence chip through a bus and is configured to store data. The storage component may include a plurality of groups of storage units 393. Each group of storage units is connected to the artificial intelligence chip through the bus. It may be understood that each group of the storage units may be a DDR SDRAM (double data rate synchronous dynamic random-access Memory).

The DDR may double the speed of SDRAM without increasing the clock frequency. The DDR allows data to he read on the rising and falling edges of the clock pulse. The speed of DDR is twice the speed of a standard SDRAM. In an embodiment, the memory may include 4 groups of storage units. Each group of storage units may include a plurality of DDR4 particles (chips). In an embodiment, four 72-bit DDR4 controllers may be arranged inside the artificial intelligence chip, where 64bit of each 72-bit DDR4 controller is for data transfer and 8 bit is for FCC (error checking and correcting) parity. It may be understood that when each group of the storage units adopts DDR4-3200 particles, the theoretical bandwidth of data transfer may reach 25600 MB/s.

In an embodiment, each group of the storage units may include a plurality of DDR SDRAMs arranged in parallel. DDR may transfer data twice per clock cycle. A DDR controller may be arranged inside the chip for controlling the data transfer and data storage of each storage unit.

The interface apparatus may be electrically connected to the artificial intelligence chip. The interface apparatus is configured to realize data transfer between the artificial intelligence chip and an external equipment (such as a server or a computer). In an embodiment, the interface apparatus may be a standard PCIe (peripheral component interconnect express) interface. For instance, data to be processed may be transferred by a server through the standard PCIe interface to the chip, thereby realizing data transfer. Optionally, when a PCIe 3.0×16 interface is adopted for transferring data, the theoretical bandwidth may reach 16000 MB/s. In another embodiment, the interface apparatus may also be another interface. The present disclosure does not restrict a specific form of the other interfaces as long as the interface unit may realize the transferring function. In addition, a computation result of the artificial intelligence chip may still be transferred by the interface apparatus to an external equipment (such as a server).

The control component is electrically connected to the artificial intelligence chip. The control component is configured to monitor a state of the artificial intelligence chip. Specifically, the artificial intelligence chip and the control component may be electrically connected through a Serial Peripheral interface (SPI). The control component may include a MC U (Micro Controller Unit). If the artificial intelligence chip includes a plurality of processing chips, a plurality of processing cores, or a plurality of processing circuits, the chip is capable of driving a plurality of loads. In this case, the artificial intelligence chip may be in different working states such as multi-load state and light-load state. The working states of the plurality of processing chips, the plurality of processing cores, and/or a plurality of processing circuits may be regulated and controlled by the control apparatus.

In a possible implementation, an electronic equipment is provided. The electronic equipment includes the artificial intelligence chip. The electronic equipment includes a data processing apparatus, a robot, a computer, a printer, a scanner, a tablet, a smart terminal, a mobile phone, a traffic recorder, a navigator, a sensor, a webcam, a server, a cloud-based server, a camera, a video camera, a projector, a watch, a headphone, a mobile storage, a wearable apparatus, a vehicle, a household appliance, and/or a medical apparatus.

The vehicle includes an airplane, a ship, and/or a car: the household electrical appliance may include a television, an air conditioner, a microwave oven, a refrigerator, an electric rice cooker, a humidifier, a washing machine, an electric lamp, a gas cooker, and a range hood; and the medical equipment may include a nuclear magnetic resonance spectrometer, a B-ultrasonic scanner, and/or an electrocardiograph.

The content of this disclosure may be better understood in accordance with the following articles:

Article A1, a quantization parameter adjustment method of a recurrent neural network, comprising:

obtaining a data variation range of data to be quantized; and

determining a first target iteration interval according to the data variation range of the data to be quantized to adjust quantization parameters in recurrent neural network computation according to the first target iteration interval, wherein the first target iteration interval comprises at least one iteration, and the quantization parameters of the recurrent neural network are configured to implement quantization of the data to be quantized in the recurrent neural network computation.

Article A2, the method of article A1, further comprising:

adjusting the quantization parameters according to a preset iteration interval when a current verify iteration is less than or equal to a first preset iteration.

Article A3. the method of article A1, wherein determining the first target iteration interval according to the data variation range of the data to be quantized comprises:

determining the first target iteration interval according to the data variation range of the data to be quantized when the current verify iteration is greater than the first preset iteration.

Article A4, the method of article A1 to article A3, wherein determining the first target iteration interval according to the data variation range of the data to be quantized to adjust the quantization parameters of the recurrent neural network computation according to the first target iteration interval comprises:

determining a second target iteration interval corresponding to the current verify iteration according to the first target iteration interval and a total count of iterations in each cycle when the current verify iteration is greater than or equal to a second preset iteration, and the current verify iteration requires adjustment in quantization parameters; and

determining an update iteration corresponding to the current verify iteration according to the second target iteration interval to adjust the quantization parameters in the update iteration, which is an iteration after the current verily iteration,

wherein the second preset iteration is greater than the first preset iteration, and a quantization adjustment process of the recurrent neural network includes a plurality of cycles, wherein iterations are not consistent in the plurality of cycles in terms of total count.

Article A5, the method of article A4, wherein determining the second target iteration interval corresponding to the current verify iteration according to the first target iteration interval and the total count of iterations comprises:

determining an update cycle of the current verify iteration according to an iterative ordering number of the current verify iteration in a current cycle and the total count of iterations in a cycle after the current cycle, wherein the total count of iterations in the update cycle is greater than or equal to an iterative ordering number of the current verify iteration; and

determining the second target iteration interval according to the first target iteration interval, the iterative ordering number and the total count of iterations in the cycle between the current cycle and the update cycle.

Article A6, the method of article A4, wherein determining the first target iteration interval according to the data variation range of the data to he quantized to adjust the quantization parameters in the recurrent neural network computation according to the first target iteration interval further comprises:

determining that the current verify iteration is greater than or equal to the second preset iteration if a convergence degree of the recurrent neural network satisfies a preset condition.

Article A7, the method of article A4, wherein the quantization parameters include a point location(s), and the point location(s) is the location of a decimal point number in the quantized data corresponding to the data to be quantized further comprises:

determining the point location(s) corresponding to an iteration(s) in a reference iteration interval according to a target data hit width corresponding to the current verify iteration and the data to he quantized in the current verify iteration to adjust the point location(s) in the recurrent neural network computation,

wherein the point location(s) corresponding to iterations) in the reference iteration interval are consistent, and the reference iteration interval includes the second target iteration interval or the preset iteration interval.

Article AS, the method of article A4, wherein the quantization parameters include a point location(s), and the point location(s) is the location of a decimal point number in the quantized data corresponding to the data to he quantized further comprises:

determining a data hit width corresponding to the reference iteration interval according to the target data bit width corresponding to the current verify iteration, wherein data bit widths corresponding to iteration(s) in the reference iteration interval are consistent, and the reference iteration interval includes the second target iteration interval or the preset iteration interval; and

adjusting the point location(s) corresponding to an iteration(s) in the reference iteration interval according to an obtained point location iteration interval and the data bit width corresponding to the reference iteration interval to adjust the point location(s) in the recurrent neural network computation,

wherein the point location iteration interval includes at least one iteration, and point locations of iterations in the point location iteration interval are consistent.

Article A9, the method of article A8, wherein the point location iteration interval is less than or equal to the reference iteration interval.

Article A10, the method of any one of article A7 to article A9, wherein the quantization parameters also include a scale factor, and the scale factor is updated synchronously with the point location(s).

Article A11, the method of article A7 to article A9. wherein the quantization parameters also include an offset, and the offset is updated synchronously with the point location(s),

Article A12, the method of any one of article A7 to article A9, further comprising:

determining a quantization error according to the data to be quantized of the current verify iteration and the quantized data of the current verify iteration, wherein the quantized data of the current verify iteration is obtained by quantizing the data to be quantized of the current verify iteration; and

determining the target data bit width corresponding to the current verify iteration according to the quantization error.

Article A13, the method of article A12, wherein determining the target data bit width corresponding to the current verify iteration according to the quantization error comprises:

increasing the data bit width corresponding to the current verify iteration to obtain the target data bit width corresponding to the current verify iteration if the quantization error is greater than or equal to a first preset threshold; or

decreasing the data bit width corresponding to the current verify iteration to obtain the target data bit width corresponding to the current verify iteration if the quantization error is less than or equal to a second preset threshold.

Article A14, the method of article A13, wherein increasing the data. bit width corresponding to the current verify iteration to obtain the target data bit width corresponding to the current verify iteration if the quantization error is greater than or equal to the first preset threshold comprises:

determining a first intermediate data bit width according to a first preset bit width stride if the quantization error is greater than or equal to the first preset threshold; and

returning to determine the quantization error according to the data to be quantized in the current verify iteration and the quantized data of the current verify iteration until the quantization error is less than the first preset threshold, wherein the quantized data of the current verify iteration is obtained by quantizing the data to be quantized of the current verify iteration according to the bit width of the first intermediate data

Article A15, the method of article A13, wherein decreasing the data bit width corresponding to the current verify iteration if the quantization error is less than or equal to the second preset threshold comprises

determining the second intermediate data bit width according to the second preset bit width stride if the quantization error is less than or equal to the second preset threshold; and

returning to determine the quantization error according to the data to he quantized in the current verify iteration and the quantized data of the current verify iteration until the quantization error is greater than the second preset threshold, wherein the quantized data of the current verity iteration is obtained by quantizing the data to be quantized of the current verify iteration according to the bit width of the second intermediate data.

Article A16, the method of any one of article A1 to article A15, wherein obtaining the variation range of data to be quantized comprises:

obtaining a variation range of the point location(s), wherein the variation range of the point location(s) is used to characterize the data variation range of the data to be quantized, and the variation range of the point locations) is positively correlated with the data variation range of the data to be quantized.

Article A17, the method of article A16, wherein obtaining the variation range of the point location(s) comprises:

determining a first average value according to the point location corresponding to a previous verify iteration before the current verify iteration and point location(s) of historical verify iteration(s) before the previous verify iteration, wherein the previous verify iteration is the verify iteration corresponding to the previous iteration interval before the reference iteration interval;

determining a second average value according to the point location corresponding to the current verify iteration and the point location(s) of the historical verify iteration(s) before the current verify iteration, wherein the point location corresponding to the current verify iteration is determined according to the target data bit width and the data to be quantized corresponding to the current verify iteration; and

determining a first error according to the first average value and the second average value, wherein the first error is used to characterize the variation range of the point location(s).

Article A18, the method of article A17, wherein determining the second average value according to the point location corresponding to the current verify iteration and the point location(s) of the historical verify iteration(s) before the current verify iteration comprises:

obtaining a preset number of intermediate moving average values, wherein each intermediate moving average value is determined according to the verify iteration of the preset number before the current verify iteration; and

determining the second average value according to the point location(s) of the current verify iteration and the preset number of intermediate moving average values.

Article A19, the method of article A17, wherein determining the second average value according to the point location corresponding to the current verify iteration and the point location(s) of the historical verify iteration(s) before the current verify iteration comprises:

determining the second average value according to the point location corresponding to the current verify iteration and the first average value.

Article A20, the method of article A17, further comprising:

updating the second average value according to an obtained data bit width adjustment value of the current verify iteration, wherein the data hit width adjustment value of the current verify iteration is determined from the target data bit width and an initial data bit width of the current verify iteration.

Article A21, the method of article A20, wherein updating the second average value according to the obtained data bit width adjustment value of the current verify iteration comprises:

decreasing the second average value according to the data bit width adjustment value of the current verify iteration if the data bit width adjustment value of the current verify iteration is greater than a preset parameter; and

increasing the second average value according to the data bit width adjustment value of the current verify iteration if the data bit width adjustment value of the current verify iteration is less than the preset parameter.

Article A22, the method of article A17, wherein determining the first target iteration interval according to the variation range of the data to be quantized comprises:

determining the first target iteration interval according to the first error, wherein the first target iteration interval is negatively correlated with the first error.

Article A23, the method of any one of article A16 to article A22, wherein obtaining the variation range of data to be quantized further comprises:

obtaining a variation trend of the data. bit width; and

determining the data variation range of the data to be quantized according to the variation range of the point location and the variation trend of the data bit width,

Article A24, the method of article A23, wherein determining the first target iteration interval according to the variation range of the data to be quantized further comprises:

determining the first target iteration interval according to the obtained first error and a second error, wherein the first error is used to characterize the variation range of the point location(s), and the second error is used to characterize the variation trend of the data bit width.

Article A25, the method of article A23, wherein determining the first target iteration interval according to the obtained first error and the second error comprises:

taking a maximum value between the first error and the second error as a target error; and

determining the first target iteration interval according to the target error, where the target error is negatively correlated with the first target iteration interval;

Article A26, the method of article A24 or article A25, wherein the second error is determined according to the quantization error,

wherein the quantization error is determined according to the data to be quantized and the quantized data of the current verify iteration, and the second error is positively correlated with the quantization error.

Article A27, the method of article A4, further comprising:

determining the first target iteration interval according to the data variation range of the data to be quantized when the current verify iteration is greater than or equal to the second preset iteration, and the second error is greater than a preset error value.

Article A28, the method of any one of article A1 to article A27, wherein the data to be quantized is at least one of neuron data, weight data or gradient data.

Article A29. A quantization parameter adjustment apparatus of a recurrent neural network, comprising a memory and a processor, wherein the memory stores a computer program, and when the processor executes the computer program, the steps of the method of any one of claims 1 to 28 are implemented.

Article A30. A computer readable storage medium, wherein the computer readable storage medium stores a computer program, and when the computer program is executed, the steps of the method of any one of claims 1 to 28 are implemented.

Article A31. A quantization parameter adjustment apparatus of a recurrent neural network, comprising:

an obtaining unit configured to obtain the data variation range of data to be quantized; and

an iteration interval determining unit, which is configured to determine a first target iteration interval according to the data variation range of the data. to he quantized to adjust the quantization parameters of a recurrent neural network computation according to the first target iteration interval, wherein the target iteration interval includes at least one iteration, and the quantization parameters of the recurrent neural network is configured to quantize the data to be quantized in the recurrent neural network computation.

Article A32, the apparatus of article A31, further comprising:

a preset interval determining unit, which is configured to adjust the quantization parameters according to the preset iteration interval when a current verify iteration is less than or equal to a first preset iteration.

Article A33, the apparatus of article A31, wherein

the iteration interval determining unit is further configured to determine the first target iteration interval according to the data variation range of the data to be quantized when the current verify iteration is greater than the first preset iteration.

Article A34, The apparatus of any one of claims 31 to 33, wherein the iteration interval determining unit comprises:

a second target iteration interval determining sub-unit, which determines a second target iteration interval corresponding to the current verify iteration according to the first target iteration interval and the total count of iterations in each cycle when the current verify iteration is greater than or equal to a second preset iteration, and the current verify iteration requires a second adjustment in quantizati on parameters; and

an update iteration determining sub-unit, which determines an update iteration corresponding to the current verify iteration according to the second target iteration interval to adjust the quantization parameters of the update iteration, which is the iteration after the current verify iteration,

wherein the second preset iteration is greater than the first preset iteration, and a quantization adjustment process of the recurrent neural network includes a plurality of cycles, wherein iterations are not consistent in the plurality of cycles in terms of total count.

Article A35, the apparatus of article A34, wherein the second target iteration interval determining sub-unit comprises:

an update cycle determining sub-unit, which determines an update cycle corresponding to the current verify iteration according to the iterative ordering number of the current verify iteration in the current cycle and the total count of iterations in cycles after the current cycle, wherein the total count of iterations in the update cycle is greater than or equal to the iterative number: and

a determining sub-unit, which determines the second target iteration interval according to the first target iteration interval, the iterative number, and the total count of iterations in the cycle between the current cycle and the update cycle.

Article A36, the apparatus of article A34, wherein

the iteration interval determining unit is further configured to determine that the current verify iteration is greater than or equal to the second preset iteration if the degree of convergence of the recurrent neural network meets the preset condition.

Article A37, the apparatus of article A34, wherein the quantization parameters includes a point location(s), and the point location(s) is the location of a decimal point number in the quantized data corresponding to the data to be quantized; the apparatus further comprises:

a quantization parameter determining unit, which is configured to determine the point location(s) corresponding to an iteration in a reference iteration interval according to a target data bit width corresponding to the current verify iteration and the data to be quantized of the current verify iteration to adjust the point location(s) in the recurrent neural network computation; and

wherein the point location(s) corresponding to iteration(s) in the reference iteration interval are consistent, and the reference iteration interval includes the second target iteration interval or the preset iteration interval.

Article A38, the apparatus of article A34, wherein the quantization parameters includes a point location(s), and the point location(s) is the location of a decimal point number in the quantized data corresponding to the data to be quantized; the apparatus further comprises:

a data bit width determining unit, which is configured to determine a data bit width corresponding to the reference iteration interval according to a target data bit width corresponding to the current verify iteration, wherein the data bit width corresponding to the iteration in the reference iteration interval is consistent, and the reference iteration interval includes the second target iteration interval or the preset iteration interval; and

a quantization parameter determining unit, which is configured to adjust the point location(s) corresponding to the iteration in the reference iteration interval according to the obtained point location iteration interval and the data bit width corresponding to the reference iteration interval to adjust the point location(s) in the neural network computation,

wherein the point location iteration interval includes at least one iteration, and point locations of iterations in the point location iteration interval are consistent.

Article A39, the apparatus of article A38, wherein the point location iteration interval is less than or equal to the reference iteration interval.

Article A40, the apparatus of article A37 to A39, wherein the quantization parameters also include a scale factor, and the scale factor is updated synchronously with the point location(s).

Article A41, the apparatus of article A37 to A39, wherein the quantization parameters also include an offset, and the offset is updated synchronously with the point location(s).

Article A42, the apparatus of article A37 to A39, wherein the data bit width determining unit comprises:

a quantization error determining sub-unit, which is configured to determine a quantization error according to the data to be quantized and the quantized data of the current verify iteration, wherein the quantized data of the current verify iteration is obtained by quantizing the data to be quantized of the current verify iteration; and

a data bit width determining sub-unit, which is configured to determine the target data bit width corresponding to the current verify iteration according to the quantization error.

Article A43, the apparatus of article A42, wherein when the data bit width determining unit is configured to determine the target data bit width corresponding to the current verify iteration according to the quantization error, the data bit width determining unit is specifically configured to:

increase the data bit width corresponding to the current verify iteration to obtain the target data bit width corresponding to the current verify iteration if the quantization error is greater than or equal to a first preset threshold; or

decrease the data bit width corresponding to the current verify iteration to obtain the target data bit width corresponding to the current verify iteration if the quantization error is less than or equal to a second preset threshold.

Article A44, the apparatus of article A43, wherein if the quantization error is greater than or equal to the first preset threshold, the data bit width determining unit is configured to increase the data bit width corresponding to the current verify iteration to obtain the target data bit width corresponding to the current verify iteration, and the data bit width determining unit is specifically configured to:

determine a first intermediate data bit width according to a first preset bit width stride if the quantization error is greater than or equal to the first preset threshold; and

return to determine the quantization error according to the data to be quantized in the current verify iteration and the quantized data of the current verify iteration until the quantization error is less than the first preset threshold, wherein the quantized data of the current verify iteration is obtained by quantizing the data to be quantized of the current verify iteration according to the bit width of the first intermediate data.

Article A45, the apparatus of article A43, wherein when the quantization error is less than or equal to the second preset threshold, the data bit width determining unit is configured to decrease the data bit width corresponding to the current verify iteration to obtain the target data bit width corresponding to the current verify iteration, and the data bit width determining unit is specifically configured to:

determine the second intermediate data bit width according to the second preset bit width stride if the quantization error is less than or equal to the second preset threshold; and

return to determine the quantization error according to the data. to be quantized in the current verify iteration and the quantized data of the current verify iteration until the quantization error is greater than the second preset threshold, wherein the quantized data of the current verify iteration is obtained by quantizing the data to be quantized of the current verify iteration according to the bit width of the second intermediate data.

Article A46, the apparatus of Article A31 to A45, wherein the obtaining unit comprises:

a first obtaining unit which is configured to obtain the variation range of the point location, wherein the variation range of the point location is used to characterize the data variation range of the data to be quantized, and the variation range of the point location is positively correlated with the data variation range of the data to he quantized.

Article A47, the apparatus of article A46, wherein the first obtaining unit comprises:

a first average value determining unit, which is configured to determine a first average value according to the point location corresponding to the previous verify iteration before the current verify iteration, and point location(s) of the historical iteration(s) before the previous verify iteration, wherein the previous verify iteration is the verify iteration corresponding to the previous iteration interval before the target iteration interval;

a second average value determining unit, which is configured to determine a second average value according to the point location corresponding to the current verify iteration and point location(s) of the historical verify iterations before the current verify iteration, wherein the point location corresponding to the current verify iteration is determined according to the target data bit width corresponding to the current verify iteration and the data to be quantized; and

a first error determining unit, which is configured to determine a first error according to the first average value and the second average value, wherein the first error is configured to characterize the variation range of the point location.

Article A48, the apparatus of article A47, wherein the second average value determining unit is specifically configured to:

obtain a preset number of intermediate moving average values, wherein each intermediate moving average value is determined according to the verify iteration of the preset number before the current verify iteration; and

determine the second average value according to the point location(s) of the current verify iteration and the preset number of intermediate moving average values.

Article A49, the apparatus of article M7. wherein the second average value determining unit is specifically configured to determine the second average value according to the point location corresponding to the current verify iteration and the first average value.

Article A50, the apparatus of article A47, wherein the second average value determining unit is configured to update the second average value according to an obtained data bit width adjustment value of the current verify iteration,

wherein the data. bit width adjustment value of the current verify iteration is determined by the target data bit width and the initial data. bit width of the current verify iteration.

Article A51, the apparatus of article A50, wherein if the second average value determining unit is configured to update the second average value according to the obtained data bit width adjustment value of the current verify iteration, the second average value determining unit is specifically configured to:

decrease the second average value according to the data bit width adjustment value of the current verify iteration if the data bit width adjustment value of the current verify iteration is greater than a preset parameter; and

increase the second average value according to the data bit width adjustment value of the current verify iteration if the data bit width adjustment value of the current verify iteration is less than the preset parameter.

Article A52, the apparatus of article A47, wherein the iteration interval determining unit is configured to determine the target iteration interval according to the first error, and the target iteration interval is negatively correlated with the first error.

Article A53, the apparatus of any one of article A46 to A52, wherein the obtaining unit further comprises:

a second obtaining unit, which is configured to acquire the change trend of the data bit width and determine the data variation range of the data to be quantified according to the variation range of the point location and the variation trend of the data bit width.

Article A54, the apparatus of article A53, wherein the iteration interval determining unit is further configured to determine the target iteration interval according to the obtained first error and the second error, wherein the first error is configured to characterize the variation range of the point location(s), and the second error is configured to characterize the variation trend of the data bit width.

Article A55, the apparatus in article A53, wherein when the iteration interval determining unit is configured to determine the target iteration interval according to the obtained first error and second error, the iteration interval determining unit is specifically configured to:

take a maximum value between the first error and the second error as a target error; and

determine the target iteration interval according to the target error, wherein the target error is negatively correlated with the target iteration interval.

Article A56, the apparatus of article A54 or 55. wherein the second error is determined according to the quantization error,

wherein the quantization error is determined according to the data to be quantized and the quantized data of the current verify iteration, and the second error is positively correlated with the quantization error.

Article A57, the apparatus of article A34, wherein

the iteration interval determining unit is further configured to determine the first target iteration interval according to the data variation range of the data to be quantized when the current verify iteration is greater than or equal to the second preset iteration, and the second error is greater than the preset error value.

Embodiments of the present disclosure have been described above, and the above descriptions are exemplary, not exhaustive, and is not limited to embodiments disclosed. The present disclosure relates to a method and an apparatus for adjusting quantization parameters of a recurrent neural network, and related products, and the above method may determine a target iteration interval according to the data variation range of the data to be quantized to adjust quantization parameters in the recurrent neural network computation according to the target iteration interval. The quantization parameter adjustment method, apparatus, and related products of the recurrent neural network of the present disclosure may improve the quantization precision, efficiency, and computation efficiency of the recurrent neural network.

1. A quantization parameter adjustment method of a recurrent neural network, comprising:
obtaining a data variation range of data to be quantized; and
determining a first target iteration interval according to the data variation range of the data to be quantized to adjust quantization parameters in recurrent neural network computation according to the first target iteration interval, wherein the first target iteration interval comprises at least one iteration, and the quantization parameters of the recurrent neural network are configured to implement quantization of the data to be quantized in the recurrent neural network computation.

2. The method of claim 1, further comprising:
adjusting the quantization parameters according to a preset iteration interval when a current verify iteration is less than or equal to a first preset iteration.

3. The method of claim 1, wherein determining the first target iteration interval according to the data variation range of the data to be quantized comprises:
determining the first target iteration interval according to the data variation range of the data to be quantized when the current verify iteration is greater than the first preset iteration.

4. The method of claim 1, wherein determining the first target iteration interval according to the data variation range of the data to be quantized to adjust the quantization parameters of the recurrent neural network computation according to the first target iteration interval comprises:
determining a second target iteration interval corresponding to the current verify iteration according to the first target iteration interval and a total count of iterations in each cycle when the current verify iteration is greater than or equal to a second preset iteration, and the current verify iteration requires adjustment in quantization parameters; and
determining an update iteration corresponding to the current verify iteration according to the second target iteration interval to adjust the quantization parameters in the update iteration, which is an iteration after the current verify iteration,
wherein the second preset iteration is greater than the first preset iteration, and a quantization adjustment process of the recurrent neural network includes a plurality of cycles, wherein iterations are not consistent in the plurality of cycles in terms of total count.

5. The method of claim 4, wherein determining the second target iteration interval corresponding to the current verify iteration according to the first target iteration interval and the total count of iterations comprises:
determining an update cycle of the current verify iteration according to an iterative ordering number of the current verify iteration in a current cycle and the total count of iterations in a cycle after the current cycle, wherein the total count of iterations in the update cycle is greater than or equal to an iterative ordering number of the current verify iteration; and
determining the second target iteration interval according to the first target iteration interval, the iterative ordering number and the total count of iterations in the cycle between the current cycle and the update cycle.

6. The method of claim 4, wherein determining the first target iteration interval according to the data variation range of the data to be quantized to adjust the quantization parameters in the recurrent neural network computation according to the first target iteration interval further comprises:
determining that the current verify iteration is greater than or equal to the second preset iteration if a convergence degree of the recurrent neural network satisfies a preset condition.

7. The method of claim 4, wherein the quantization parameters include a point location(s), and the point location(s) is a location of a decimal point number in quantized data corresponding to the data to be quantized, and the method further comprises:
determining the point location(s) corresponding to an iteration(s) in a reference iteration interval according to a target data bit width corresponding to the current verify iteration and the data to be quantized in the current verify iteration to adjust the point location(s) in the recurrent neural network computation,
wherein the point location(s) corresponding to iteration(s) in the reference iteration interval are consistent, and the reference iteration interval includes the second target iteration interval or the preset iteration interval.

8. The method of claim 4, wherein the quantization parameters include a point location(s), and the point location(s) is a location of a decimal point number in quantized data corresponding to the data to be quantized, and the method further comprises:
determining a data bit width corresponding to the reference iteration interval according to the target data bit width corresponding to the current verify iteration, wherein data bit widths corresponding to iteration(s) in the reference iteration interval are consistent, and the reference iteration interval includes the second target iteration interval or the preset iteration interval; and
adjusting the point location(s) corresponding to an iteration(s) in the reference iteration interval according to an obtained point location iteration interval and the data bit width corresponding to the reference iteration interval to adjust the point location(s) in the recurrent neural network computation,
wherein the point location iteration interval includes at least one iteration, and point locations of iterations in the point location iteration interval are consistent.

9. The method of claim 8, wherein the point location iteration interval is less than or equal to the reference iteration interval.

10. The method of claim 7, wherein the quantization parameters also include a scale factor, and the scale factor is updated synchronously with the point location(s).

11. The method of claim 7, wherein the quantization parameters also include an offset, and the offset is updated synchronously with the point location(s).

12. The method of claim 7, further comprising:
determining a quantization error according to the data to be quantized of the current verify iteration and the quantized data of the current verify iteration, wherein the quantized data of the current verify iteration is obtained by quantizing the data to be quantized of the current verify iteration; and
determining the target data bit width corresponding to the current verify iteration according to the quantization error.

13. The method of claim 12, wherein determining the target data bit width corresponding to the current verify iteration according to the quantization error comprises:
increasing the data bit width corresponding to the current verify iteration to obtain the target data bit width corresponding to the current verify iteration if the quantization error is greater than or equal to a first preset threshold; or
decreasing the data bit width corresponding to the current verify iteration to obtain the target data bit width corresponding to the current verify iteration if the quantization error is less than or equal to a second preset threshold.

14. The method of claim 13, wherein increasing the data bit width corresponding to the current verify iteration to obtain the target data bit width corresponding to the current verify iteration if the quantization error is greater than or equal to the first preset threshold comprises:
determining a first intermediate data bit width according to a first preset bit width stride if the quantization error is greater than or equal to the first preset threshold; and
returning to determine the quantization error according to the data to be quantized in the current verify iteration and the quantized data of the current verify iteration until the quantization error is less than the first preset threshold, wherein the quantized data of the current verify iteration is obtained by quantizing the data to be quantized of the current verify iteration according to the bit width of the first intermediate data.

15. The method of claim 13, wherein decreasing the data bit width corresponding to the current verify iteration if the quantization error is less than or equal to the second preset threshold comprises:
determining the second intermediate data bit width according to the second preset bit width stride if the quantization error is less than or equal to the second preset threshold; and
returning to determine the quantization error according to the data to be quantized in the current verify iteration and the quantized data of the current verify iteration until the quantization error is greater than the second preset threshold, wherein the quantized data of the current verify iteration is obtained by quantizing the data to be quantized of the current verify iteration according to the bit width of the second intermediate data.

16. The method of claim 1, wherein obtaining the variation range of data to be quantized comprises:
obtaining a variation range of the point location(s), wherein the variation range of the point location(s) is used to characterize the data variation range of the data to be quantized, and the variation range of the point location(s) is positively correlated with the data variation range of the data to be quantized.

17. The method of claim 16, wherein obtaining the variation range of the point location(s) comprises:
determining a first average value according to the point location corresponding to a previous verify iteration before the current verify iteration and point location(s) of historical verify iteration(s) before the previous verify iteration, wherein the previous verify iteration is the verify iteration corresponding to the previous iteration interval before the reference iteration interval;
determining a second average value according to the point location corresponding to the current verify iteration and the point location(s) of the historical verify iteration(s) before the current verify iteration, wherein the point location corresponding to the current verify iteration is determined according to the target data bit width and the data to be quantized corresponding to the current verify iteration; and
determining a first error according to the first average value and the second average value, wherein the first error is used to characterize the variation range of the point location(s).

18. The method of claim 17, wherein determining the second average value according to the point location corresponding to the current verify iteration and the point location(s) of the historical verify iteration(s) before the current verify iteration comprises:
obtaining a preset number of intermediate moving average values, wherein each intermediate moving average value is determined according to the preset number of verify iterations before the current verify iteration; and
determining the second average value according to the point location(s) of the current verify iteration and the preset number of intermediate moving average values;
and wherein determining the second average value according to the point location corresponding to the current verify iteration and the point location(s) of the historical verify iteration(s) before the current verify iteration comprises:
determining the second average value according to the point location corresponding to the current verify iteration and the first average value.

19. (canceled)

20. The method of claim 17, further comprising:
updating the second average value according to an obtained data bit width adjustment value of the current verify iteration, wherein the data bit width adjustment value of the current verify iteration is determined from the target data bit width and an initial data bit width of the current verify iteration.

21 to 29. (canceled)

30. A computer readable storage medium, wherein the computer readable storage medium stores a computer program, and when the computer program is executed, the steps of the method of claim 1 are implemented.

31-57. (canceled)
